(19) United States
(12) Patent Application Publication
(10) Pub. No.: US 2009/0215477 A1
(43) Pub. Date: Aug. 27, 2009

(54) INTELLIGENT MULTIPLE DEVICE FILE SHARING IN A WIRELESS COMMUNICATIONS SYSTEM

(75) Inventors: Thien H. Lee, Hillsboro, OR (US); Anand Janakiraman, San Diego, CA (US); Murtuza T. Chhatriwala, San Diego, CA (US); Manuel E. Jaime, Solana Beach, CA (US); Mark Kelly Murphy, Hillsboro, OR (US)

Correspondence Address: QUALCOMM INCORPORATED, 5775 MOREHOUSE DR., SAN DIEGO, CA, 92121, US

(73) Assignee: QUALCOMM, Incorporated, San Diego, CA (US)

(21) Appl. No.: 12/270,496

(22) Filed: Nov. 13, 2008

Related U.S. Application Data
(60) Provisional application No. 61/031,939, filed on Feb. 27, 2008.

(51) Int. Cl. H04M 1/00; H04W 4/00

(52) U.S. Cl. 455/466; 455/550.1

(57) ABSTRACT

Systems and methodologies are described that facilitate communication between a plurality of devices identified by mobile infospheres. The devices can be associated with a mobile infosphere based on ownership, for example, where the mobile infospheres are identified by a mobile phone number. A registry server can store information regarding devices in each mobile infosphere, and communication between the devices within a mobile infosphere or devices in other mobile infospheres can be facilitated by providing stored access parameters. In addition, data transferred among the devices can be transcoded to meet capabilities of disparate devices with respect to memory, bandwidth, available codes, etc. Moreover, a file system can aggregate shared files and folders from a plurality of mobile infosphere devices to provide seamless access to available accessible content.

### CROSS-REFERENCE TO RELATED APPLICATIONS

This application claims the benefit of U.S. Provisional Patent application Ser. No. 61/031,939 entitled “FILE SYSTEM-BASED ACCESS FOR MOBILE PHONE AND COMPUTER INTELLIGENT MULTI-MEDIA FILE SHARING IN A WIRLESS COMMUNICATIONS SYSTEM” which was filed Feb. 27, 2008. The entirety of the aforementioned application is herein incorporated by reference.

### BACKGROUND

I. Field

The following description relates generally to wireless communications, and more particularly to personal data communication utilizing wireless networks.

II. Background

Wireless communication systems are widely deployed to provide various types of communication content such as, for example, voice, data, and so on. Typical wireless communication systems may be multiple-access systems capable of supporting communication with multiple users by sharing available system resources (e.g. bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), etc.

Moreover, many people own additional electronic devices that store content, whether for productivity or entertainment purposes. For example, people have desktop computers, laptop computers, personal digital assistants (PDA), digital video recorders (DVR), digital music players (e.g., MP3 players), digital cameras, locally or remotely located dedicated file servers, and/or the like. These devices, along with mobile devices, separately store information and media related to one or more people who own the devices. Furthermore, some devices allow access to other devices or for the other devices to locally store content. Thus, for example, one can store pictures from a digital camera onto a computer for viewing. Similarly, DVRs can allow viewing of media stored thereon through a networked computer, etc. In this regard, one can share personal data throughout a private network for accessing by different devices. However, attempts to expose personal data outside of a home network typically utilize remotely located storage as security is more easily implemented in this regard. Also, attempts to expose data from personal devices are typically proprietary to one device, usually a personal computer, and/or are not easily shared with other users. This is typically due to security concerns with infiltrating a personal network.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating association of personal electronic devices in a mobile infosphere. Using a mobile device, access to the devices in the mobile infosphere can be attained based at least in part on security features inherent in mobile devices. Thus, the mobile device can be utilized to view media stored on the devices in the mobile infosphere. In one example, media can be transcoded before being sent to the mobile device to create a preview, lesser quality, or smaller sized media file for more efficient transmission. Moreover, data from mobile infospheres can be shared among users to and from various mobile infosphere devices. In this regard, a registry server can be utilized to associate various mobile infosphere devices with a user; in one example, a mobile phone number related to the user can be utilized to identify the user's mobile infosphere. Further, the mobile device can be utilized to authorize access to one or more devices in a user's mobile infosphere.

According to related aspects, a method that facilitates securely accessing devices of a mobile infosphere is provided. The method comprises receiving a short message service (SMS) message including an encrypted payload in response to a registration request to a registry server. The method also includes decrypting the payload using a first public key from the registry server and a private key related to a second public key transmitted in the registration request and encrypting the payload with the private key and the first public key. Moreover, the method includes transmitting the encrypted payload to complete registry server registration creating a mobile infosphere.

Another aspect relates to a wireless communications apparatus. The wireless communications apparatus can include at least one processor configured to obtain a SMS message in response to requesting mobile infosphere initialization in a registry server and decrypt the SMS message using a public key of the registry server and a private key transmitted in requesting mobile infosphere initialization. The processor is further configured to encrypt the decrypted SMS message using the public key and private key pair for verification and transmit the encrypted SMS message to the registry server to initialize the mobile infosphere. The wireless communications apparatus additionally includes a memory coupled to the at least one processor.

Yet another aspect relates to a wireless communications apparatus that initializes a mobile infosphere with a registry server. The wireless communications apparatus can comprise means for decrypting a SMS message received in response to a request for mobile infosphere initialization and means for encrypting the SMS message with a private key having a related public key specified in the request for mobile infosphere initialization. The wireless communications apparatus can additionally include means for transmitting the encrypted SMS to verify the request for mobile infosphere initialization.

Still another aspect relates to a computer program product, which can have a computer-readable medium including code for causing at least one computer to receive a SMS message including an encrypted payload in response to a registration request to a registry server. The computer-readable medium can also comprise code for causing the at least one computer to decrypt the payload using a first public key from the registry server and a private key related to a second public key transmitted in the registration request. Moreover, the computer-readable medium can comprise code for causing the at least one computer to encrypt the payload with the private key and the first public key and code for causing the at least one computer to transmit the encrypted payload to complete registry server registration creating a mobile infosphere.

According to a further aspect, a method for associating a plurality of devices in a mobile infosphere is provided. The method includes receiving a request to initialize a mobile infosphere from a mobile device comprising a public key for encrypting communication to the mobile device. The method also comprises transmitting a SMS message comprising a payload encrypted with a public key of a mobile device and a private key to the mobile device and decrypting a response message with the public key of the mobile device and the private key. Further, the method includes initializing the mobile infosphere for the mobile device based at least in part on comparing the response message with the SMS message.

Another aspect relates to a wireless communications apparatus. The wireless communications apparatus can include at least one processor configured to encrypt a SMS message using a public key of a mobile device and a private key. The processor is further configured to transmit the SMS message to the mobile device to verify a request received for initializing a mobile infosphere related to the mobile device and initialize the mobile infosphere upon receiving a verification SMS from the mobile device. The wireless communications apparatus additionally includes a memory coupled to the at least one processor.

Yet another aspect relates to a wireless communications apparatus that facilitates initializing a mobile infosphere for subsequent device association. The wireless communications apparatus can comprise means for transmitting a SMS message to a mobile device to verify a request received to associate the mobile device with a mobile infosphere. The wireless communications apparatus can additionally include means for decrypting an initialization SMS received from the mobile device using a public key received from the mobile device and a private key.

Still another aspect relates to a computer program product, which can have a computer-readable medium including code for causing at least one computer to receive a request to initialize a mobile infosphere from a mobile device comprising a public key for encrypting communication to the mobile device. The computer-readable medium can also comprise code for causing the at least one computer to transmit a SMS message comprising a payload encrypted with a public key of a mobile device and a private key to the mobile device. Moreover, the computer-readable medium can comprise code for causing the at least one computer to decrypt a response message with the public key of the mobile device and the private key and code for causing at least one computer to initialize the mobile infosphere for the mobile device based at least in part on comparing the response message with the SMS message.

According to another aspect, a method that facilitates communication among a plurality of mobile infosphere devices is provided. The method includes transmitting a request for access parameters for at least one of a plurality of mobile infosphere devices from a registry server that associates a plurality of devices with a mobile infosphere based at least in part on a mobile phone number for the mobile infosphere. The method further includes utilizing the access parameters to establish secure communications with the at least one mobile infosphere device.

Another aspect relates to a wireless communications apparatus. The wireless communications apparatus can include at least one processor configured to transmit a request for access parameters related to a mobile infosphere device, the request identifies the device using a mobile phone number associated with the mobile infosphere. The processor is further configured to establish a secure communication session with the mobile infosphere device using the access parameters. The wireless communications apparatus additionally includes a memory coupled to the at least one processor.

Yet another aspect relates to a wireless communications apparatus that facilitates secure mobile infosphere device communication. The wireless communications apparatus can comprise means for transmitting a request for access parameters related to a mobile infosphere device identifying a phone number related to the mobile infosphere in the request and means for receiving the access parameters stored in a registry server in response to the request. The wireless communications apparatus can additionally include means for establishing a secure connection with the mobile infosphere device based at least in part on the access parameters.

Still another aspect relates to a computer program product, which can have a computer-readable medium including code for causing at least one computer to transmit a request for access parameters for at least one of a plurality of mobile infosphere devices from a registry server that associates a plurality of devices with a mobile infosphere based at least in part on a mobile phone number for the mobile infosphere. The computer-readable medium can also comprise code for causing the at least one computer to utilize the access parameters to establish secure communications with the at least one mobile infosphere device.

According to yet another aspect, a method for facilitating secure mobile infosphere device communication is provided. The method comprises specifying access parameters, including an address and a public key corresponding to a locally stored private key, in a request to associate with a mobile infosphere created by a registry server. Moreover, the method comprises establishing a secure connection with a device based at least in part on access parameters and encrypting communications over the secure connection with the private key.

Another aspect relates to a wireless communications apparatus. The wireless communications apparatus can include at least one processor configured to transmit access parameters for communicating with the wireless communications apparatus in a request to associate with a mobile infosphere created in a registry server and establish a secure communication session with a device using the access parameters. The processor is further configured to secure data for communication in the session utilizing security keys related to the access parameters. The wireless communications apparatus additionally includes a memory coupled to the at least one processor.

Yet another aspect relates to a wireless communications apparatus that facilitates secure communication between mobile infosphere devices. The wireless communications apparatus can comprise means for associating with a mobile infosphere specifying access parameters for communication and means for establishing a secure connection with a device based at least in part on the access parameters. The wireless communications apparatus can additionally include means for encrypting data over the secure connection utilizing a private key related to a public key specified in the access parameters.

Still another aspect relates to a computer program product, which can have a computer-readable medium including code for causing at least one computer to specify access parameters, including an address and a public key corresponding to a locally stored private key, in a request to associate with a mobile infosphere created by a registry server. The computer-readable medium can also comprise code for causing the at least one computer to establish a secure connection with a device based at least in part on access parameters. The computer-readable medium can further comprise code for causing the at least one computer to encrypt communications over the secure connection with the private key.

According to another aspect, a method for facilitating secure mobile infosphere device communication is provided. The method includes associating a plurality of devices with a mobile infosphere identified by a mobile phone number. The method further includes providing access parameters for the plurality devices to one or more disparate devices.

Another aspect relates to a wireless communications apparatus. The wireless communications apparatus can include at least one processor configured to maintain a mobile infosphere index comprising a number of devices each associated with one of a plurality of mobile device phone numbers. The wireless communications apparatus additionally includes a memory coupled to the at least one processor.

Yet another aspect relates to a wireless communications apparatus that facilitates communication between devices of participating in mobile infospheres. The wireless communications apparatus can comprise means for creating a mobile infosphere identified by a mobile phone number upon registering a primary mobile device. The wireless communications apparatus can additionally include means for associating one or more disparate devices with the mobile infosphere to facilitate subsequent communication with the one or more disparate devices.

Still another aspect relates to a computer program product, which can have a computer-readable medium including code for causing at least one computer to associate a plurality of devices with a mobile infosphere identified by a mobile phone number. The computer-readable medium can also comprise code for causing the at least one computer to provide access parameters for the plurality devices to one or more disparate devices.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a mobile infosphere in accordance with various aspects set forth herein.

FIG. 2 is an illustration of an example wireless communications environment that facilitates accessing mobile infosphere devices.

FIG. 3 is an illustration of an example wireless communications environment that facilitates providing mobile infosphere device access via femtocell.

FIG. 4 is an illustration of an example wireless communications environment that effectuates managing mobile infospheres.

FIG. 5 is an illustration of an example wireless communications environment that facilitates accessing mobile infosphere devices according to registry server access parameters.

FIG. 6 is an illustration of an example wireless communications system that transcodes data communicated between mobile infosphere devices.

FIG. 7 is an illustration of example interfaces that can be utilized to access one or more mobile infosphere devices.

FIG. 8 is an illustration of an example interface that facilitates defining security parameters for one or more mobile infosphere devices.

FIG. 9 is an illustration of example interfaces that can be utilized to access one or more mobile infosphere devices via a file system.

FIG. 10 is an illustration of an example methodology that facilitates creating a mobile infosphere.

FIG. 11 is an illustration of an example methodology that facilitates associating devices with a mobile infosphere.

FIG. 12 is an illustration of an example methodology that facilitates establishing connection with one or more mobile infosphere devices.

FIG. 13 is an illustration of an example methodology that facilitates transcoding data requested from one or more mobile infosphere devices.

FIG. 14 is an illustration of an example methodology that facilitates grouping shared files and folders into a seamless aggregate view.

FIG. 15 is an illustration of an example mobile device that facilitates providing access to shared files and folders of one or more mobile infosphere devices.

FIG. 16 is an illustration of an example wireless network environment that can be employed in conjunction with the various systems and methods described herein.

FIG. 17 is a schematic block diagram illustrating a suitable operating environment.

FIG. 18 is a schematic block diagram of a sample computing environment.

FIG. 19 is an illustration of an example system that requests mobile infosphere initialization.

FIG. 20 is an illustration of an example system that initializes a mobile infosphere based at least in part on a received request.

FIG. 21 is an illustration of an example system that communicates with a mobile infosphere device utilizing one or more access parameters.

FIG. 22 is an illustration of an example system that provides one or more access parameters in associating with a mobile infosphere to facilitate subsequent communications from one or more devices.

FIG. 23 is an illustration of an example system that creates a mobile infosphere.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

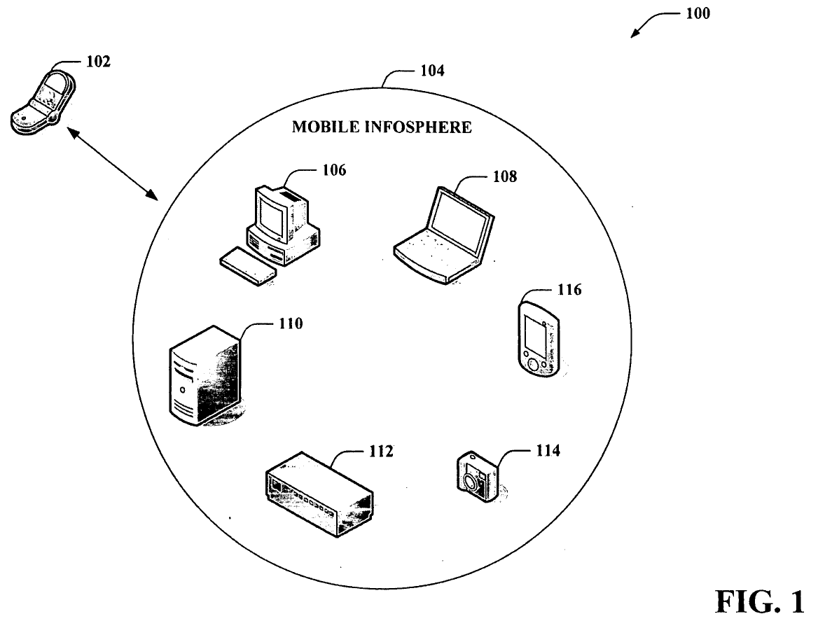

Referring now to FIG. 1, an example wireless communications system 100 is illustrated in accordance with various embodiments presented herein. The system 100 comprises a mobile device 102 and a mobile infosphere 104 related to a user or other entity. The mobile infosphere 104 can comprise various devices related to a user that store and/or provide access to media content, such as a personal computer 106, a laptop computer 108, a disparate computer or storage server 110, a digital video recorder (DVR) 112, a digital camera 114, MP3 player 116, a sophisticated car, a video game console, and/or the like. For example, the mobile device 102 or a number of other mobile devices can be a part of the mobile infosphere 104 as well. In an example, one or more devices can be communicatively coupled to any number of disparate devices in the mobile infosphere 104 to provide file sharing or other communication among the devices. Moreover, one or more devices in the mobile infosphere 104 can be communicatively coupled to one or more devices or systems outside the mobile infosphere 104 to provide file or communication access to other devices.

According to an example, the mobile device 102 can access one or more devices within a related user's mobile infosphere 104 to obtain media and/or other data from the devices. In one example, the mobile device 102 can connect directly to one or more devices, or indirectly through one or more disparate devices of the mobile infosphere 104 and/or an access component for the mobile infosphere. For instance, the mobile device 102 can connect to the desktop computer 106 to retrieve media thereon or on one or more devices accessible by the desktop computer 106. In another example, the devices of the mobile infosphere can participate in a network, such as a local area network (LAN), wide area network (WAN), and/or the like, and the mobile device 102 can gain access to the network to communicate with the one or more devices in the mobile infosphere 104. In this regard, a trust relationship can be established between the mobile device 102 and/or one or more devices in the mobile infosphere 104 and/or devices providing access to the devices in the mobile infosphere 104.

In one example, the mobile device 102 can communicate with one or more devices in the infosphere 104 to receive media or other data, and the data can be transcoded for the mobile device 102 before it is transmitted. For example, the mobile phone 102 can request content from the DVR 112, such as a list of available television shows. The DVR 112, or another device within or related to the mobile infosphere, can transcode the available television shows into a smaller media file so the mobile device 102 can more efficiently receive the content or a portion thereof For example, the DVR 112 or associated device can generate a preview of one or more television shows for transmission to the mobile device 102. Additionally or alternatively, for example, the DVR 112 or associated device can transcode the television show to a lesser video and/or audio quality to allow more efficient transmission of the television shown to the mobile device 102. In another example, a digital camera 114 picture can be converted from a high resolution accustomed to digital cameras (e.g., 8+ megapixel) to a lower resolution for transmission to the mobile device 102. It is to be appreciated that the communication can utilize substantially any protocol, such as transmission control protocol/internet protocol (TCP/IP), user datagram protocol (UDP), and/or similar customized protocols.

Furthermore, one or more devices of the mobile infosphere 104 can operate behind a firewall such that incoming communications ports can be blocked. Thus, as described herein, one or more centralized access servers can be provided to establish open communication with one or more devices of the mobile infosphere 104. The access server can utilize a public address to allow connection from the mobile device 102. Thus, in one example, the desktop computer 106 can connect to the access server opening a communication channel therewith (e.g., by utilizing a service and/or other software), and one or more disparate mobile infosphere 104 devices can communicate with and be accessed via the desktop computer 106. It is to be appreciated that the access server can support a number of mobile infospheres as well. In another example, the other devices of the mobile infosphere 104, such as DVR 112, digital camera 114, MP3 player 116, etc., where equipped with independent networking technologies, can also execute a service to connect directly with an access server to provide access to content. The mobile device 102 can communicate with the access server to receive the content. Moreover, the communication described above can be two-way, such that the mobile device 102 can transmit content to other devices in the mobile infosphere 104, such as media content and/or data or commands; for example, the mobile device 102 can be utilized to send control commands to one or more devices in the mobile infosphere 104, such as to record shows on the DVR 112, execute a process on the computer 106, and/or the like.

According to another example, a mobile infosphere 104 can provide access to devices outside of the infosphere as well. For example, the one or more share points from the mobile infosphere 104 to the mobile device 102 can be made available to one or more disparate mobile devices or other devices, whether or not those devices are in the infosphere or any infosphere at all. To facilitate this functionality, a registry server can be provided that identifies mobile infospheres 104 based at least in part on a mobile phone 102 number, as this number is typically unique and can relate to a mobile infosphere 104. The devices exposed as part of the mobile infosphere 104 can be registered under the mobile phone 102 number such that disparate devices can access mobile infosphere 104 devices at least in part by utilizing the mobile phone 102 number with an identifier related to the specific device. It is to be appreciated that the root mobile phone 102 number can provide a listing of accessible share points in the mobile infosphere 104 as well. In one example, the registry server can setup devices related to a mobile device 102 in the mobile infosphere 104 through a registration process using mobile device 102. For example, security keys can be utilized to ensure authorized access during and following device setup.

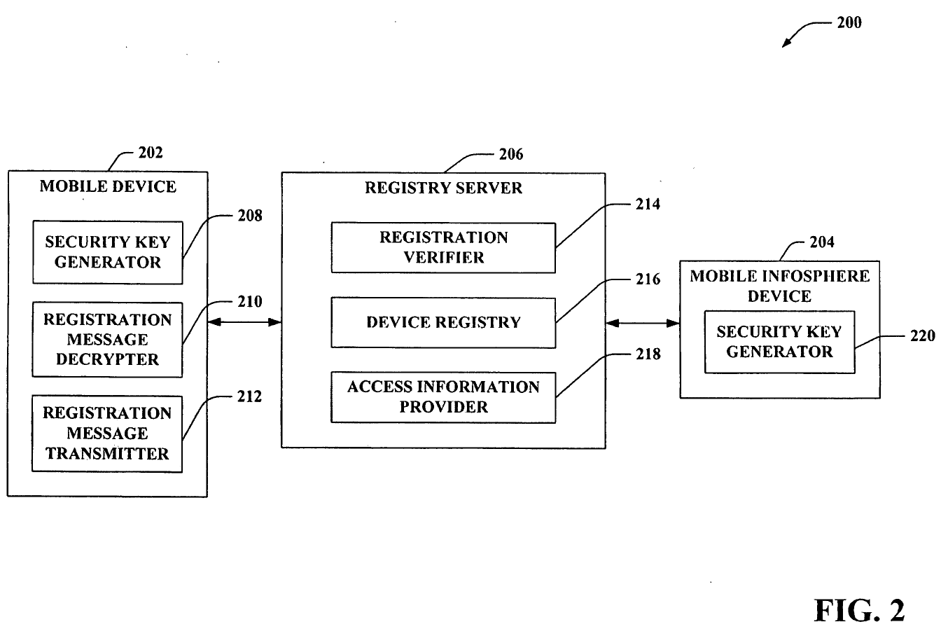

Turning to FIG. 2, illustrated is a wireless communications environment 200 that facilitates communication between a mobile device 202 and a mobile infosphere 204, or one or more devices in the infosphere 204, via a registry server 206. According to an example, the registry server 206 can execute locally to a given mobile infosphere 204 or can provide access to a number of infospheres. The mobile device 202 can include a security key generator 208 that creates a security key pair upon registration for authenticating subsequent communications, a registration message decrypter 210 that can apply one or more decryption keys to a registration message, and a registration message transmitter 212 that can transmit an original registration message to the registry server 206. The registry server 206 can include a registration verifier 214 that ensures authorization between one or more devices of the mobile infosphere 204 according to the mobile device 202, a device registry 216 that stores information regarding the disparate devices in the mobile infosphere 204, and an access information provider 218 that facilitates communication with devices of the mobile infosphere 204. Additionally, the mobile infosphere device 204 can include a security key generator 220 that generates a key pair upon registration. Moreover, the devices in the mobile infosphere 204 can include those enumerated above and substantially any other electronic devices.

The registry server 206 allows a primary device to be registered; this can be the mobile device 202 whose number can be utilized to identify the device 202 and/or one or more devices of the mobile infosphere 204. In one example, the security key generator 208 can create a public/private key pair for registration. The mobile device 202 can register with the registry server 206 providing the public key and/or other information, such as mobile phone number, which the registry server 206 can place in the device registry 216. The registration verifier 214 can additionally ensure valid registration; for example, the registration verifier 214 can transmit a message to the mobile device 202, such as a short message service (SMS) message, to challenge the provided number. The message can be encrypted with a private key related to the registry server 206 along with the public key generated by the security key generator 208 and provided by the mobile device 202 upon registration.

Upon receiving the message, the registration message decrypter 210 can decrypt the message using the private key, generated with the public key by the security key generator 208 upon registration, as well as the public key of the registry server 206. Subsequently, the registration message transmitter 212 can transmit the message back to the registry server 206. If the registration verifier 214 determines the received message to be substantially similar to the message it encrypted and transmitted originally, then registration can be successful, and the mobile device 202 can be added to the device registry 216 under its provided phone number. Once the mobile device 202 is registered, other devices from the mobile infosphere 204 can be added deriving from the mobile device 202 phone number. It is to be appreciated that this process can be performed automatically; for example, by a binary runtime environment for wireless (BREW) application or other service upon installation thereof and/or the like. In addition, the mobile device 202 can transmit a personal identification number (PIN), on request or otherwise, to the registry server 206 for subsequent device authentication, as described herein. The device registry 216 can store the associated PIN as a hash, in one example (e.g., using secure hash algorithm (SHA), etc.), for later confirmation.

Once the mobile device 202 is registered with the registry server 206 as a primary node (e.g., related to the phone number), other devices in the mobile infosphere 204 can be registered as extensions of the primary node. For example, the security key generator 220 can create a public/private security key pair and request registration from the registry server 206. During the request, the mobile infosphere device 204 can specify a mobile phone number with which to be associated, an extension, an internet protocol (IP) address or other access information, the public security key, and/or the like. Upon receiving the parameters, the registration verifier 214 can ensure the association of the mobile infosphere device 204 with the mobile device 202. For example, the registration verifier 214 can transmit an SMS to the mobile device 202 to confirm association with the mobile infosphere device 204; the SMS can include data such as the public key, which the user of the mobile device 202 can verify against that of the mobile infosphere device 204. The association can be accepted by transmitting an SMS back to the registration verifier 214 indicating success; this can be performed manually and/or as part of an application executing on the mobile device 202, for example. Once successful, the device registry 216 can store the parameters for accessing the mobile infosphere device 204. In another example, the mobile infosphere device 204 can additionally provide the PIN, entered earlier by the mobile device 202, upon registering with the registry server 206. In this example, the registration verifier 214 can verify the PIN with that entered earlier by the mobile device 202 to associate the mobile infosphere device 204 with the mobile device 202. It is to be appreciated that where registration information is modified, such as an IP address change in a dynamic IP configuration or a public/private key renewal for refreshed security, the mobile infosphere device 204 can notify the registry server 206 via secure message encrypted with the private key of the device 204, for instance.

After adding the mobile infosphere device 204 to the mobile infosphere defined by the device registry 216, the access information provider 218 can facilitate access to the mobile infosphere device 204, for example by transmitting access parameters for the mobile infosphere device 204 to requesting devices. It is to be appreciated that the access information provider 218 can also provide access parameters to the mobile device 202 from a mobile infosphere device 204 or other device as well. For example, the access information provider 218 can receive requests to access the mobile infosphere device 204 from the mobile device 202, from a BREW or other application executing thereon, in one example. The access information provider 218 can transmit relevant access information to the mobile device 202 for accessing the mobile infosphere device 204, including an IP address to access the device, the public key for encrypting data, etc. Subsequently, the mobile device 202 can establish connection, such as a TCP/IP connection, with the mobile infosphere device 204 (e.g., to receive media content on the device, etc.) utilizing the relevant access parameters. For example, the mobile device 202 can encrypt communications with its private key and the public key of the mobile infosphere device 204 and transmit the communications using the IP address provided to access the mobile infosphere device 204. The mobile infosphere device 204 can receive communications and decrypt using its private key and the public key of the mobile device 202, which it can have previously received from the registry server 206 and/or mobile device 202. Upon decrypting, the mobile infosphere device 204 can verify the validity of the communication where the keys successfully decrypt. Subsequently, the mobile infosphere device 204 can communicate back to the mobile device 202 utilizing similar techniques. It is to be appreciated that the mobile infosphere device 204 can be protected by a firewall, router, or other device that utilizes network address translation (NAT) for communication between the device 204 and other networks. In this regard, there can be no public IP address for accessing the mobile infosphere device 204. Thus, the mobile infosphere device 204 can provide a proxy server IP address or other ways to access the mobile infosphere device 204 for storage in the device registry 216, which can be subsequently provided to devices desiring access to the mobile infosphere device 204.

According to another example, the mobile infosphere device 204 can request communications with the mobile device 202 by obtaining information from the access information provider 218. In particular, as the mobile device 202 can be accessed through a cellular network, in one example, and may not have an IP address, the access information provider 218 can provide instructions and/or parameters related to transmitting an SMS to the mobile device 202. This can be accomplished by providing the information to an application executing on the mobile infosphere device 204, in one example, so as to appear seamless to a user of the device. Thus, the mobile infosphere device 204 can transmit the SMS to the mobile device 202 comprising an IP address to access the mobile infosphere device 204, as described previously, to request communication establishment. The mobile device 202 can subsequently contact the mobile infosphere device 204 via the IP address to establish communications, over TCP/IP, UDP, and/or the like, for example. In addition, the mobile device 202 and mobile infosphere device 204 can obtain relevant security keys from the registry server 206 when needed for communication between the devices. Moreover, other devices within the infosphere can communicate with one another by obtaining relevant information from the registry server 206, as registered in the device registry 216, for communicating, such as address, security keys, and/or the like as described.

Once connected, the mobile device 202 and mobile infosphere device 204 can perform substantially any sharing task. For example, the devices 202 and 204 can share files, such as media files, productivity files, etc. In another example, the mobile infosphere device 204 can provide file access to other devices that are connected to or otherwise associated with the mobile infosphere device 204. In addition, the mobile device 202 can perform other functions on the mobile infosphere device 204. In one example, the mobile device 202 can control the mobile infosphere device 204, such as total control (e.g. remote desktop), or operate as a game controller and/or the like. In another example, the mobile device 202 can play audio through speakers associated with the mobile infosphere device 204. Thus, securely connecting the mobile device 202 and mobile infosphere device 204 can facilitate sharing of many devices to be utilized in many ways. It is to be appreciated that the examples shown are not intended to limit the subject matter described herein, rather these are mere examples of substantially limitless configurations defined by connecting the mobile device 202 and mobile infosphere device 204.

It is to be appreciated that the registry server 206 can execute at one or more places accessible by the mobile device 202 and/or the mobile infosphere devices 204. Thus, a wireless network access provider can host the registry server 206, in one example. In another example, the registry server 206 can execute on a femtocell, which is essentially a retail base station that can be installed in a residence. The femtocell connects to a wireless network access provider via a broadband backhaul link (e.g. through cable internet, digital subscriber line (DSL) T1/T3, and/or the like) and provides radio wireless network access much like a base station. Thus, in one example, the femtocell can communicate with the wireless network access provider over the same network as one or more mobile infosphere devices 204, and in this regard has direct access to the devices as well. Thus, the mobile device 202 can connect to the registry server 206 on the femtocell through the wireless network access provider for accessing the mobile infosphere devices 204 as described. In yet another example, the registry server 206 can execute on the mobile device 202 such that mobile infosphere devices 204 can contact the mobile device (e.g., via SMS) to register with the mobile device 202. Then the mobile device 202 can locally store information necessary to communicate with the mobile infosphere device(s) 204. It is also to be appreciated that some mobile infosphere devices 204 can depend on other device for network access. Thus, devices 204 can connect to a personal computer, for example, through various mediums, such as a MP3 player or digital camera coupled via universal serial bus (USB), and/or the like. The computer can provide requisite network access to the devices 204 for participation in the mobile infosphere as described, for example.

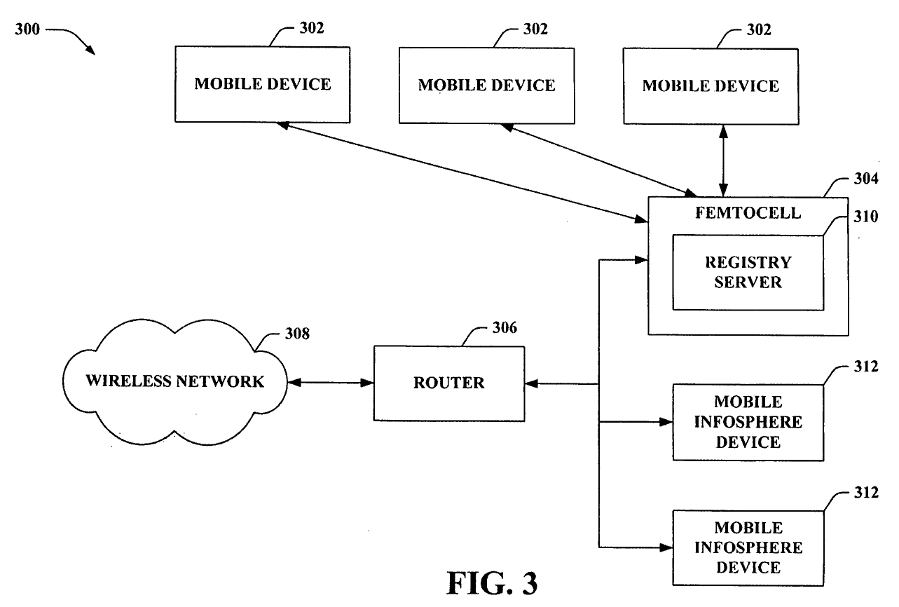

Now turning to FIG. 3, a wireless communications system 300 is shown that facilitates maintaining a registry server on a femtocell to provide efficient access for devices communicating therewith. A plurality of mobile devices 302 are provided that can communicate with a femtocell 304 to receive wireless communication access, for example. The femtocell 304 can provide wireless transmission services to the mobile devices 302 communicating over a router 306 with a wireless network 308 (e.g., via a broadband backhaul link, such as cable, DSL, and/or the like as described). The femtocell 304 can maintain a local registry server 310, which can be replicated from a more centralized registry server in one example. In addition, the router 306 can be a home or business router, such as an Ethernet router, that can facilitate communication between a plurality of devices, such as mobile infosphere devices 312 as well as the femtocell.

According to an example, as the femtocell 304 is communicatively coupled with the wireless network 308, it can receive access to a centralized registry server and maintain a replicated local registry server 310. Thus, the femtocell 304 can provide registry server 310 access to the mobile devices 302 and/or mobile infosphere devices 312 for accessing devices registered with the registry server 310 (whether registered directly or via a more centralized registry server from which the registry server 310 receives connection parameters. In addition, devices, such as the mobile devices 302 or mobile infosphere devices 312, can register with the registry server 310. In this regard, the devices can be accessed only via the local registry server 310 or the registry server 310 can forward the access parameters to a more centralized registry server for more public access of the devices.

Moreover, in one example, the femtocell 304 can act as an access server via the wireless network. As described herein, an access server can be provided to allow access to devices that are not publicly addressable. The access server can be utilized to establish connection with the devices to allow public access to the devices; in this regard, the femtocell 304, having direct access to the wireless network 308 through the broadband backhaul link, can allow other devices (not shown) to communicate with the mobile infosphere devices 312 that are in the same network as the femtocell 304. Thus, though the mobile infosphere devices 312 can be in a private network, where the router 306 can provide public outgoing access for the devices, since the femtocell 304 is communicatively coupled with the wireless network 308, it can act as a router providing access to the mobile infosphere devices 312 via the wireless network 308 for example.

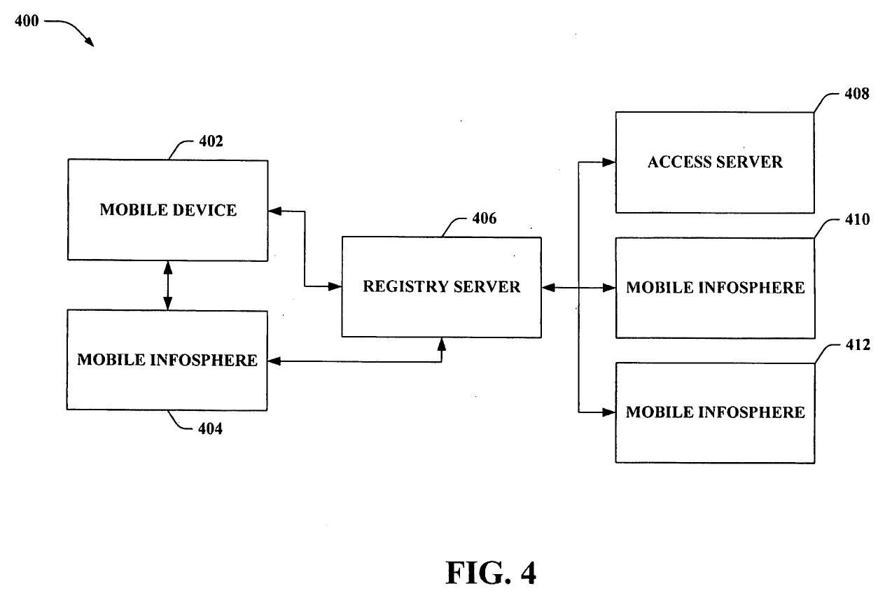

Now referring to FIG. 4, illustrated is a wireless communications system 400 that can facilitate device access among multiple devices within and outside of a given mobile infosphere. A mobile device 402 is provided that can be associated with mobile infosphere 404, as well as a registry server 406 that can store and provide information regarding accessing one or more mobile infospheres or related devices, an access server 408 that can facilitate access to one or more infosphere devices behind a firewall or otherwise inaccessible via direct protocol communications, and additional mobile infospheres 410 and 412. In one example, the mobile device 402 can register as a primary node with a registry server 406, as described supra, and devices from the mobile infosphere 404 can register with the registry server 406 as devices associated with the mobile device 402. Thus, the mobile device 402 can communicate with devices in mobile infosphere 404 using access parameters defined in the registry server 406. As shown, the registry server 406 can register devices of a plurality of mobile infospheres 404, 410, and 412. In one example, the registry server 406 can create an index of registration information for the plurality of infospheres that can be utilized to provide requested access. The index can be similar to the following index.

| | | | | | Last |
|---|---|---|---|---|---|
| Infosphere | Extension | Node Class | Public Key | IP Address | Update |
| 8581111111 | | Mobile | (512-bit RSA) | N/A | <time> |
| 8581111111 | PC | Primary PC | (512-bit RSA) | XX.XX.XX.XX | <time> |
| 8582222222 | | Mobile | (512-bit RSA) | N/A | <time> |
| 8582222222 | PC | Primary PC | (512-bit RSA) | XX.XX.XX.XX | <time> |
| 8582222222 | PC2 | Secondary PC | (512-bit RSA) | XX.XX.XX.XX | <time> |
| . . . | . . . | . . . | . . . | . . . | . . . |

In this regard, the infosphere column relates to the number of the mobile device (e.g., mobile phone number) to which devices are associated. The extension identifies the device within the mobile infosphere, the class is the type of device, the public key is that generated in the private/public key pair described earlier that can be used to encrypt communications to the device, and the IP address can be utilized to communicate with the device. As described, where a device does not have a publicly accessible IP address, it can register with an access server 408 that can have a public IP address and act like a proxy to allow access to the device. Thus, access server 408 can support multiple infosphere devices (not shown), and in one example, another column in the index of the registry server 406 can specify whether the IP address relates to such a proxy or access server 408. In this regard, mobile infosphere devices can connect to the access server 408, via an executing application and/or the like utilizing a TCP/IP protocol, etc., and the access server 408 can provide access to the mobile infosphere device by communicating with devices desiring such access. In this case, the IP address in the index can be that of the access server 408, for example.

According to an example, mobile device 402 can request access to one or more devices of a mobile infosphere 404, 410, or 412, or devices utilizing access server 408 to provide access thereto, by requesting access from the registry server 406 using the infosphere number and extension. Thus, in one example, a uniform naming convention (UNC) type of access request can be specified, e.g. \\8582222222\PC. Upon specifying the request, the registry server 406 can accordingly retrieve additional information regarding the device for which access is requested. It is to be appreciated that the access request can be seamlessly intercepted by an application executing on the requesting device, in one example, and routed to the registry server 406. The registry server 406, in this example, can return the public key and IP address related to the infosphere device to the mobile device 402 and/or an application executing thereon. Subsequently, the mobile device 402 can attempt connection with the PC related to infosphere 8582222222. In the application example, the application can seamlessly request such access from the PC and provide the application with a list of available media and/or other files on the PC. The mobile device 402 can access the media and/or files it is authorized to access. It is to be appreciated that the registry server 406 can be spread among additional redundant registry servers 406, in one example, to facilitate availability of the information comprised in the server 406.

Authorization for accessing devices outside of a given infosphere can be effectuated by the registry server 406, in one example. Additionally or alternatively, the devices within the mobile infosphere 404, 410, 412 can control authorization for disparate requesting devices and/or a device of the infospheres 404, 410, 412 can be responsible for authorization regarding the devices in its infosphere. Additionally, media and/or other data communicated between devices of an infosphere 404, 410, 412 and/or mobile device 402 can be transcoded upon transfer. Thus, for example, where a requesting device has communication bandwidth capabilities below a threshold, content can be constrained to a lower quality, e.g. resolution or sound quality for example, to facilitate more efficient transfer of the media or other data. In another example, the media or other data can be cropped to include only a preview, resulting in smaller size and thus more efficient transfer. Moreover, in one example, the transcoding can be performed based on limited memory requirements, available codecs, and/or the like with respect to a receiving device.

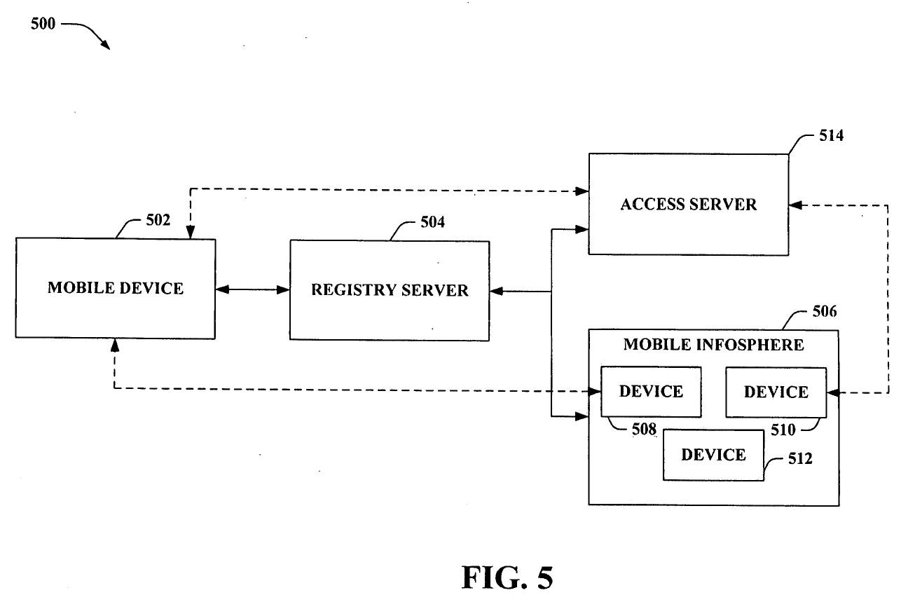

Turning now to FIG. 5, an example wireless communication network 500 is illustrated showing communication between devices registered with one or more infospheres. A mobile device 502 is shown that registers with the registry server 504 as described previously. In addition, the mobile device 502 can utilize the registry server 504 to receive access parameters for communicating with disparate devices. Further, a mobile infosphere 506 is provided that is logically created by the registry server 504 upon associating devices 508, 510, and 512 with one another (e.g., via a common mobile phone number as described). Moreover, an access server 514 is provided to allow access to one or more devices not having public access parameters.

According to an example, the mobile device 502 and devices 508, 510, and 512 can register with the registry server 504 to associate with a mobile infosphere; devices 508, 510, and 512 associate with mobile infosphere 506, and the mobile device 502 can create its own mobile infosphere to which other devices can be associated as described. Subsequently, as shown supra, the mobile device 502 and/or devices 508, 510, and 512 can obtain access parameters for other devices for communication therewith. As shown, the mobile device 502 can communicate directly with device 508. It is to be appreciated that there can be an authentication and/or authorization step required before communication as described. In another example, the device 508 can initiate communications with the mobile device 502.

In another example, devices can be privately addressed, such as those behind a firewall or router that provides external public network or Internet access. In this example, the access server 514 can be utilized to provide access to the device. Thus, device 510 can be such a device that is not publicly addressable. Device 510, upon registering with the registry server 504, can provide access parameters that utilize the access server 514 to facilitate communication with the device 510. In this regard, the device 510 can also establish communication with the access server 514, which can be subsequently utilized to by the access server 514 to transmit communications from disparate devices. Thus, the mobile device 502 can request access to the device 510 retrieving access parameters from the registry server 504. Utilizing the parameters, the mobile device 502 can communicate with the access server 514, which can act as a proxy allowing access to the device 510 as shown. Therefore, mobile infosphere device access can be provided for publicly addressed as well as privately addressed devices in this regard.

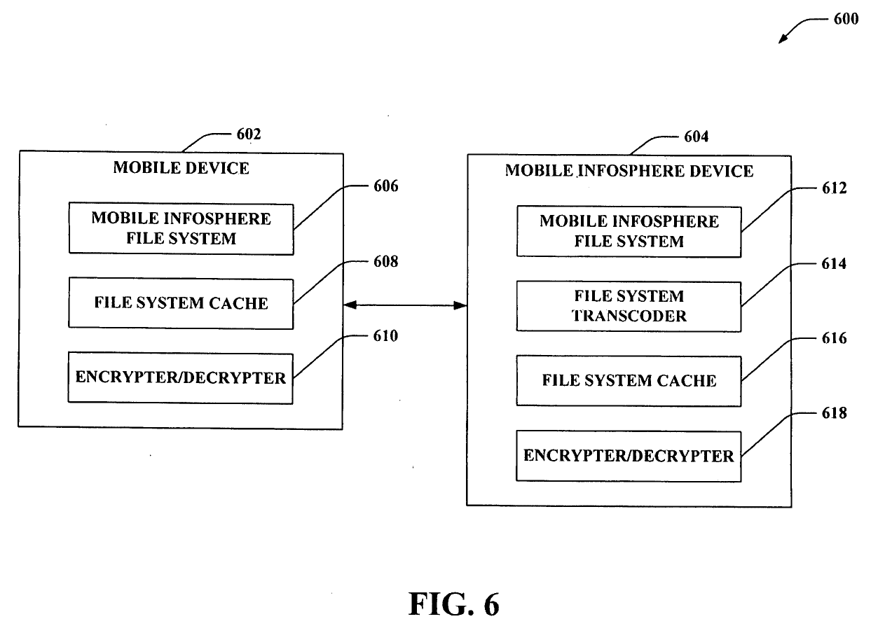

Now referring to FIG. 6, an example wireless communication network 600 is displayed where disparate devices having a mobile infosphere file system can communicate media or other information. In particular, a mobile device 602 is shown communicating with a mobile infosphere device 604, which can be a disparate mobile device or substantially any device belonging to a mobile infosphere as described above (e.g., a desktop/laptop computer, digital camera, DVR, MP3 player, etc.). For example, the devices 602 and 604 can have established connection via a registry server as described and can be members of the same or different mobile infospheres. The mobile device 602 can comprise a mobile infosphere file system 606 that provides seamless access to media and other data or files of devices in the same or disparate mobile infospheres, a file system cache 608 that stores such media, files, and/or information for accessing such, and an encrypter/decrypter 610 that facilitates secure communication with the mobile infosphere device 604 by applying private and/or public keys as described supra. The mobile infosphere device 604 also includes a mobile infosphere file system 612 that similarly provides seamless access to files on one or more infosphere devices. The mobile infosphere device 604 also includes a file system transcoder that can modify files before providing access to one or more requesting devices. The mobile infosphere device 604 further comprises a file system cache 616 and encrypter/decrypter 618 similar to those of the mobile device 602.

According to an example, the mobile infosphere file systems 606 and 612 can execute respectively on the mobile device 602 and mobile infosphere device 604. The file systems 606 and 612 can allow seamless access to each other and/or other devices. In one example, the file systems 606 and 612 can access a registry server and establish secured communication using security keys as described above. Thus, in one example, a user of the mobile device 602 can indicate that it wants to access the mobile infosphere device 604, for example by trying to access the device by \\<mobile_number>\<extension> as described previously. The mobile infosphere file system 606 can obtain this request and contact a registry server to access information, such as an address and/or public key, to access the mobile infosphere device 604. Additionally or alternatively, at least a portion of such information can be stored in the file system cache 608 from an earlier access, and can come from there. In another example, the file system cache 608 can store contents of mobile infosphere device 604 shared directories such that navigation may not require access to the mobile infosphere device 604.

In this example, communications can be established between the mobile device 602 and mobile infosphere device 604 by contacting the device through the provided IP address and encrypting the message using encrypter/decrypter 610 to apply the public key of the mobile infosphere device 604 and the private key of the mobile device 602, for example. In one example, a user of the mobile device 602 can browse to the mobile infosphere device 604, and the mobile infosphere file system 606 can contact the mobile infosphere file system 612 on the mobile infosphere device to navigate the file system. Communications can continue between the file systems 606 and 612 to provide directory or folder listings, for example. It is to be appreciated that this communication can be in response to automated requests as well, for example the mobile device 602 can automatically update its file system cache 608 with new content in a folder of the mobile infosphere 604 device without interaction by the user.

The mobile infosphere file system 606 can be utilized to request media content or other files from the mobile infosphere file system 612. The mobile infosphere file system 612 can determine bandwidth/memory capabilities of the mobile device 602, or other requester, as well as codecs installed on the mobile device 602, etc. This information can be requested directly from the mobile device 602 and/or from the system registry, or substantially any device with the requisite information. Based on the acquired parameters, the file system transcoder 614 can transcode the media or other data requested to be utilized by the mobile device 602 or other devices. For example, where a high resolution photo (e.g., 8 megapixel) is selected for display on the mobile device, the file system transcoder 614 can reduce the resolution of the photo (e.g., 640 pixels by 480 pixels), causing the media to require less data communication. Thus, transferring the photo between the mobile infosphere file systems 612 and 606 is more efficient, and the photo does not take up as much space on the mobile device 602. Similarly, the file system transcoder 614 can reduce the transmission size of streaming content, such as audio or video, by lowering the quality (e.g., the data rate, frame refresh, etc.), providing a portion of the content at first for a preview, and/or the like. Moreover, for content where the mobile device 602 does not have correct codecs or other viewers/readers to access the content, the file system transcoder 614 can transcode the file into one or more formats that can be accessed by the mobile device 602 before transmitting. It is to be appreciated that while transmitting information, the encrypter/decrypter 618 can be utilized to encrypt the information for decryption by encrypter/decrypter 610. In another example, the mobile infosphere file systems 606 and 612 can utilize other agreed security methods. It is to be appreciated that the mobile infosphere device 604 can request access to and browse the mobile device 602 in a similar regard for media and/or other files, including voice messages, etc.

In another example, the mobile infosphere file system 606 and/or 612 can provide seamless access to shared files/folders from a plurality of devices in a mobile infosphere. In this example, the mobile infosphere file system 606 and/or 612 can aggregate the shared folders and documents from the devices of a given mobile infosphere in one location, such as at the root mobile numbers. Thus, if a device accesses \\8582222222, one or more mobile infosphere file systems 612 of a device within the 8582222222 mobile infosphere, can aggregate available shares from substantially all registered devices in the root view so no extension (e.g., .PC, .PC2, .DVR, etc.) is needed. Moreover, in another example, the file system cache 608 and/or 616 of one or more devices in a mobile infosphere can hold data from other devices shared locations, for example where the device whose cache is being utilized is more often available than the sharing device. In another example, the caches of various devices can be utilized for redundant storage. In another example, an application (not shown) executing on a device, such as mobile device 602, can utilize the mobile infosphere file system 606 to seamlessly provide access to devices of other infospheres as well. Thus, in one example, the application can allow a user to select from a list of movies, where the movies are aggregated from one or substantially all sources the mobile device 602 has access to within and/or outside of its mobile infosphere using the methods and functionalities described herein. To the user, however, the movies appear available and source is not important. Additionally, to this end, files to be shared can be classified into groups (e.g., music, movies, productivity, etc.). This can be accomplished by utilizing a common schema file that identifies files in groups, using a file wrapper with the classification information in a header, and/or the like.

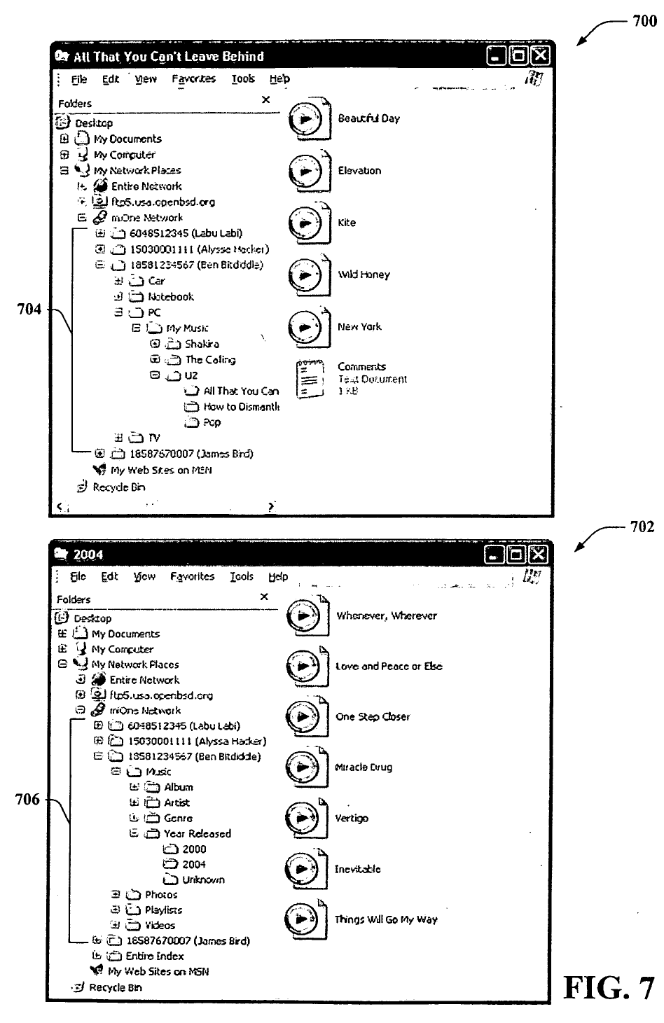

Now turning to FIG. 7, example interfaces 700 and 702 of a file system utilizing mobile infosphere device association are displayed. Example interface 700 shows a file system of a computer or other mobile infosphere device where an available network lists a plurality of navigable mobile infospheres (shown at 704), such as 6048512345, 15030001111, 18581234567, and 18587670007. As described previously, the file system can establish connection with one or more devices of the disparate infospheres by gathering requisite information from the registry server, which can also include receiving authorization to do so. The interface 700 shows a breakout of navigable infosphere devices for mobile infosphere 18581234567, including extensions labeled car, notebook, PC, and TV. As shown in the interface 700, a music folder is navigated to for the device having the PC extension in the mobile infosphere, and folders/files can be retrieved from the device as shown. It is to be appreciated, as described, that where the accessing device requires or desires, files can be transcoded for improved accessing.

Example interface 702 also illustrates a file system for a device that shows an available network listing a plurality of navigable mobile infospheres (shown at 706). In this example, rather than a traditional folder structure, the shared files and/or folders of disparate devices of the mobile infosphere can be logically grouped. As described previously, a schema file and/or headers, for example, can be utilized to accommodate such grouping. A file system can determine the grouping for disparate shared folders and/or files and display the groups as if from one device. Thus, device boundaries within the infosphere appear seamless to the user of the file system. It is to be appreciated that the seamless usage can be applied across multiple infospheres in one example. Thus, interface 702 shows a general music folder, as well as photos, playlists, and videos, directly under the 18581234567 mobile infosphere folder with subfolders related to song details (e.g., album, artist, genre, etc.). In this regard, the logical groupings can display files from a plurality of accessible devices regardless of device boundaries, and in fact, files can appear under multiple logical groupings. Thus, a song can appear under Music\Genre\Rock as well as Music\Year\Released\2004, for example. It is to be appreciated that other groupings can be applied as well using substantially any logical relation.

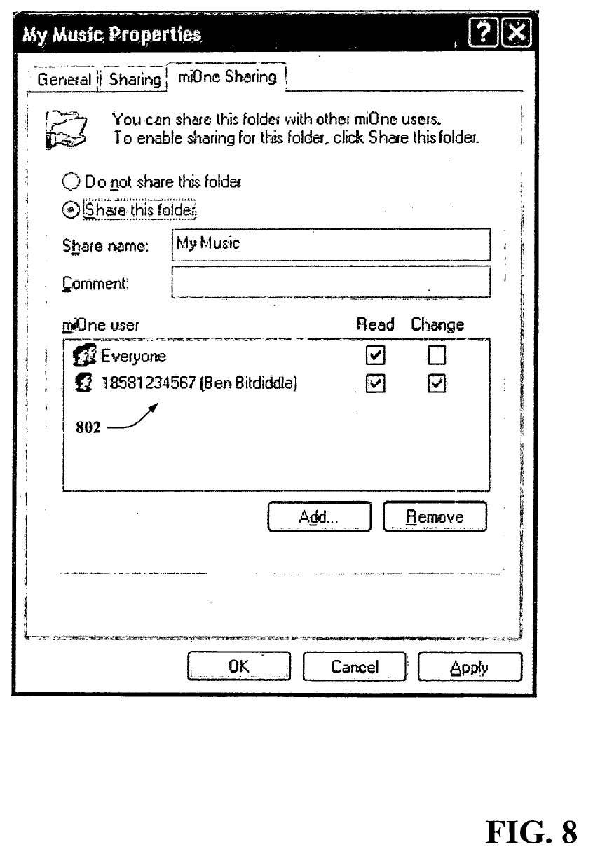

Referring now to FIG. 8, illustrated is an example interface 800 that facilitates specifying access properties for one or more mobile infosphere share points in a mobile infosphere file system. In one example, a file system can be extended to support mobile infospheres; thus in this example, a sharing tab is shown for the mobile infosphere functionality. Access can be added to the folder for devices of mobile infosphere 18581234567 as shown at 802. Additionally, in one example, access can be provided for certain device of given mobile infospheres as well. The interface shown, for example, can relate to providing access to folders on a computer that is a member of the infosphere. Additionally, however, the computer interface 800 can control access for folders on other devices as well, and the chosen security profiles and parameters can be transmitted to other devices that control authorization, in one example. Moreover, the interface 800 can control access to the logical groupings described above that can be defined in schema files, headers, etc. The defined security parameters can be included in the schema files or, as mentioned, transmitted to a device controlling authorization.

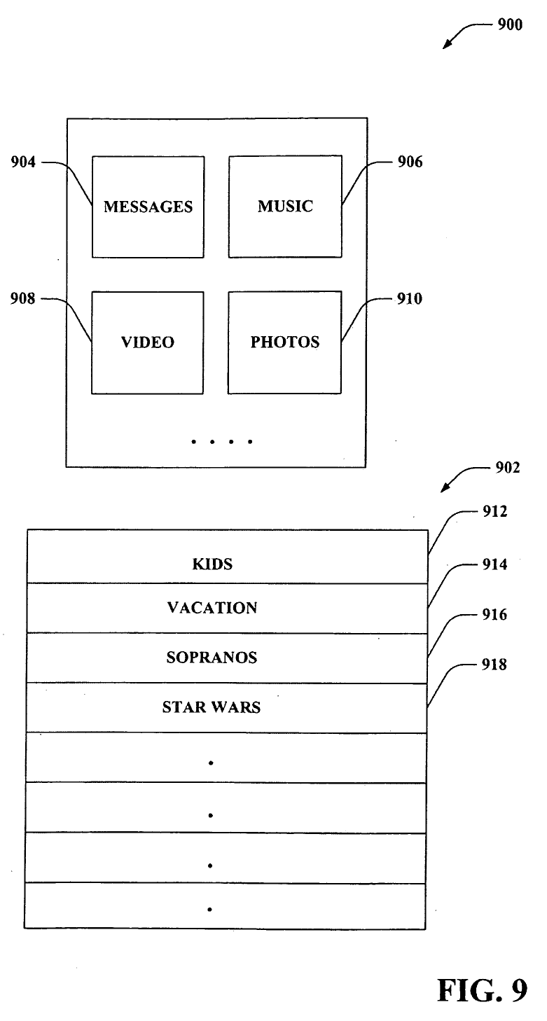

Turning to FIG. 9, example interfaces 900 and 902 of an application that utilizes a mobile infosphere file system to provide media content to a device is shown. Interface 900 relates to an initial display that can allow a user to choose a group of content to view. As mentioned, files of one or more devices within and/or outside of a given infosphere can be logically grouped by content type, and further by information related to the type; in another example, the interface 900 or file system can infer a group based at least in part on tags in the file, file type, and/or the like. For example, the interface 900 shows available types of messages 904, music 906, video 908, and photos 910. In one example, a device using the interface 900 can be a mobile device such as a cellular phone and/or the like. The interface 900 can leverage a mobile infosphere file system to access additional devices within or outside of the mobile infosphere. In one example, the interface 900 can aggregate sources based on logical grouping and display one or more of the logical groups on initial interface 900. Thus, messages 904 can include not only messages on the device, but also from other mobile infosphere devices, such as a computer, DVR, automobile (maintenance reminders, for example), etc. In addition, music 906, videos 908, and photos 910 can be aggregated from a plurality of mobile infosphere devices. Moreover, as described, sources outside of a given mobile infosphere can be aggregated as well where the requesting device is authorized.

In one example, the user can select the video 908 option from the initial interface 900, which can result in display of the interface 902. Interface 902 shows a list of available videos and/or categories, folders, or groups from aggregated sources. Thus, some videos can be resident on the device displaying the interface 902 while others are from other devices in a related mobile infosphere or other mobile infospheres. The interface 902, in one example, displays options labeled kids 912, vacation 914, Sopranos 916, and Star Wars 918. Thus, the kids 912 option can, in one example, be a specified logical grouping of videos from a plurality of devices, an inferred grouping of videos (e.g., by evaluating a tag and/or file or folder name), a shared folder from a single device labeled kids, a collection of shared folders from a plurality of devices labeled kids, and/or the like. The vacation 914 can be a similar collection of videos and/or a single video on the device utilizing the interface 902 or other accessible device, such as a video camera with communicative capabilities and/or attached to a computer, within or outside of the mobile infosphere. The Sopranos 916 grouping can be, for example, episodes of the Sopranos recorded on one or more DVRs, computers, etc. internal or external to a mobile infosphere of the device utilizing the interface 902. Similarly, Star Wars 918 can be a video resident on one or more accessible devices.

According to an example, as described, the content can be transcoded before delivering to a device having decreased memory and/or bandwidth capabilities (or incompatible codecs, for example). Thus, the video actually received can be of lower quality (frames per second, resolution, and/or the like). In another example, a preview of the video can be generated and/or transmitted upon selection to ensure the user wants more of the video before transmitting the remainder. The preview can be an initial portion of the video and/or formed from various portions, for example. In this regard, transmission of the media can be more efficient. In addition, for example, the interface 900, when aggregating source groups, can automatically request portions of the content. For instance, where messages 904 are shared from other devices, the interface 900 or underlying file system can request subject lines and/or an initial amount of characters, and subsequently request the remainder if the user desires to view a larger portion of the message, for example.

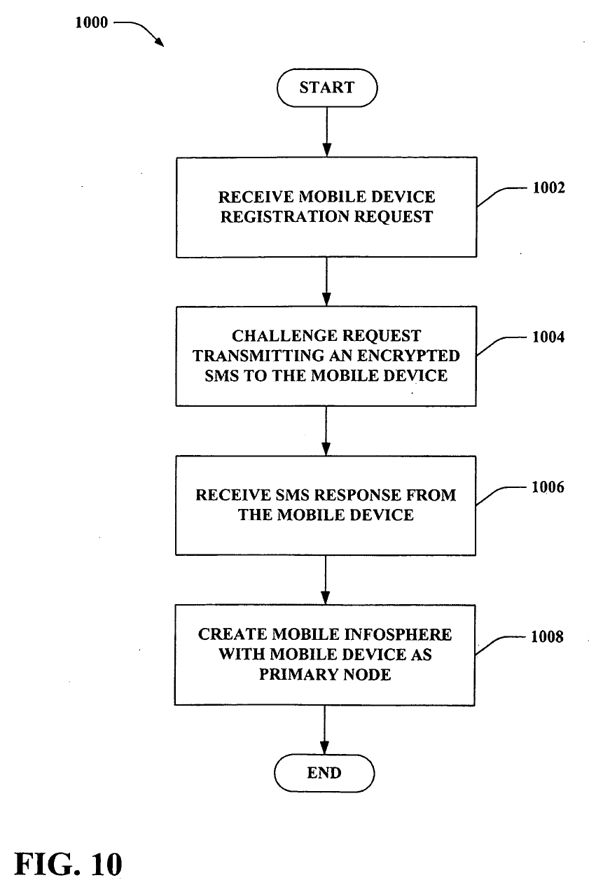

Referring to FIGS. 10-14, methodologies relating to communicating data among devices participating in a mobile infosphere are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 10, illustrated is a methodology 1000 that facilitates registering a mobile device as a primary node of a mobile infosphere. At 1002, a registration request can be received from a mobile device. The registration can relate to creating a mobile infosphere based from the mobile device (e.g., where the device phone number can be utilized as an anchor to which additional devices can be associated). At 1004, the registration request is challenged by transmitting an encrypted SMS to the mobile device. For example, the SMS can be encrypted utilizing a public key of the mobile device, provided upon registration request, and a private key for which the mobile device received a corresponding public key during registration. It is to be appreciated that the mobile device can receive the SMS and decrypt it using the public key it received and its private key related to the public key it transmitted upon registration, for example. At 1006, an SMS response can be received from the mobile device, which can be based at least in part on previous decryption and/or interpretation of the SMS transmitted SMS. At 1008, a mobile infosphere can be created with the mobile device as primary node based at least in part on the SMS response. For example, once the mobile infosphere is created, devices can be associated with the infosphere, which can increase accessibility to the device from disparate devices as described.

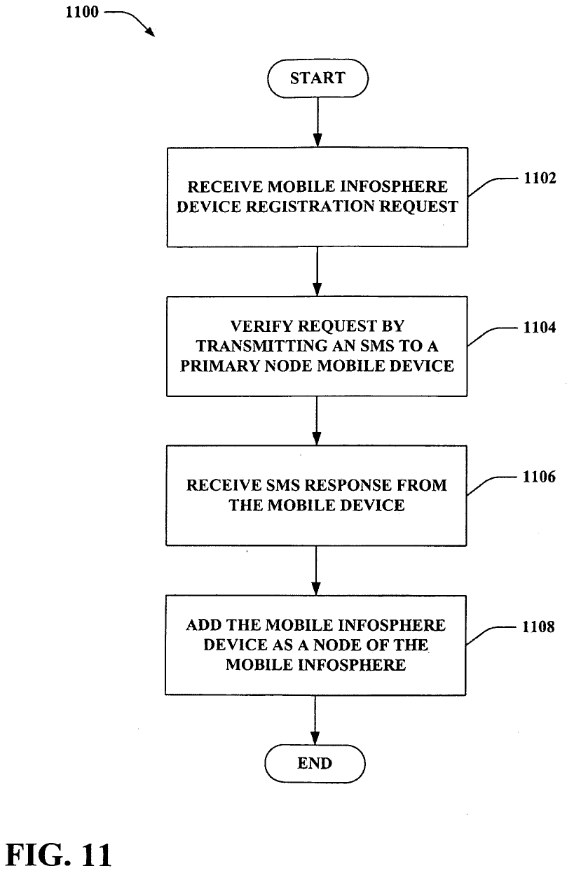

Now referring to FIG. 11, a methodology 1100 that facilitates registering one or more devices in a mobile infosphere is illustrated. At 1102, a mobile infosphere device registration request can be received. This can be from substantially any type of device, as described, including a computer, laptop, server, MP3 player, DVR, camera, PDA, car, video game console, and/or the like. The device can request registration to a mobile infosphere associated with a mobile device owned by a user of the device. In this regard, the device, once registered, can be accessed based at least in part on the mobile phone number. At 1104, the request for registration is verified by transmitting an SMS to the mobile device, which is the primary node for the mobile infosphere. In one example, the SMS can comprise an identification number entered at the device, which can be verified against an identification number provided by the mobile device at an earlier point in time. At 1106, an SMS response regarding the registration can be received from the mobile device. At 1108, the mobile infosphere device can be added as a node of the mobile infosphere based at least in part on the SMS response. In this regard, the mobile device can control devices it is associated with by manual and/or automated confirmation as described.

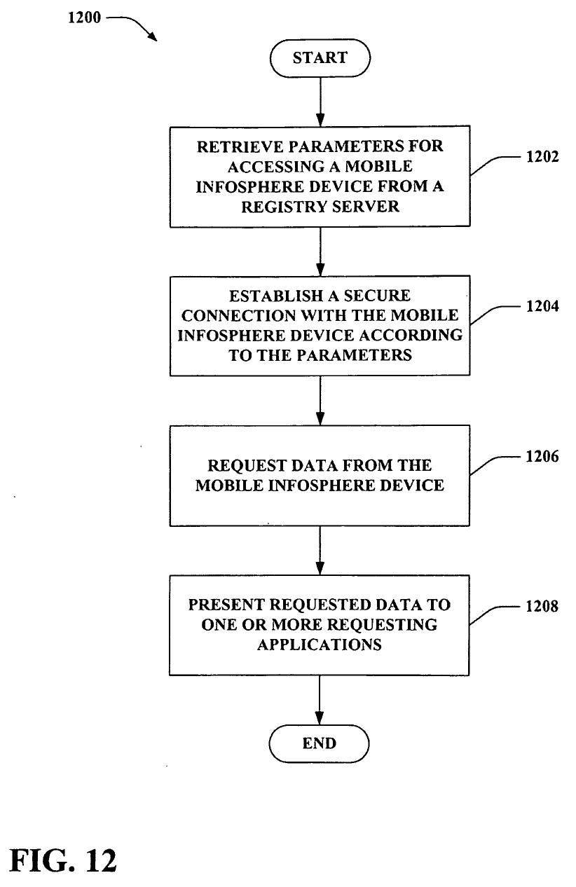

Turning now to FIG. 12, a methodology 1200 is displayed that facilitates establishing communications between mobile infosphere devices. At 1202, parameters for accessing a mobile infosphere device are received from a registry server. The device for which access is requested can be substantially any device including, but not limited to, a primary node mobile device or devices associated therewith in the mobile infosphere for the primary node mobile device. Parameters received for accessing the device can include an address, security keys, and/or the like as described supra. At 1204, a secure connection can be established with the mobile infosphere device according to the parameters. Thus, an access location and/or encryption/decryption keys can be determined or inferred from the parameters and utilized to access the device. At 1206, data can be requested from the mobile infosphere device. In one example, this can be shared file and/or folder listings, media content, documents, productivity files, and/or the like. At 1208, the requested data can be presented to one or more requesting applications. As described, an requesting application can be leveraging a file system to provide available shared folders and/or files. Similarly, the application can be a media player that streams the data from the mobile infosphere device for playback, for example.

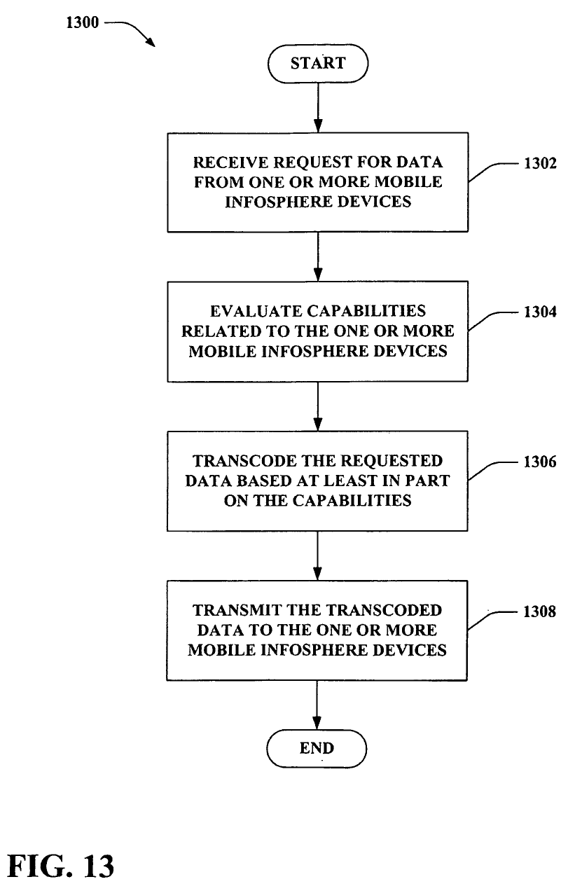

Referring to FIG. 13, a methodology 1300 for transcoding data transmitted to one or more mobile infosphere devices is shown. At 1302, a request for data can be received from one or more infosphere devices. The request, for example, can specify media content and/or other data desired by the mobile infosphere device or user thereof. At 1304, capabilities related to the one or more mobile infosphere devices can be evaluated. For example, the mobile infosphere device can be a mobile phone operating on a cellular network that is limited both in memory and bandwidth. Moreover, the mobile phone may or may not have certain codecs required to view media. Thus, theses capabilities can be evaluated and utilized to transcode the requested data at 1306. As described, this can include lowering quality of the data (e.g., frames per second and/or resolution of video or images), generating a preview of the data, formatting the data for a given codec available on the receiving mobile infosphere device, and/or the like. At 1308, the transcoded data can be transmitted to the one or more mobile infosphere devices for viewing or other usage thereof.

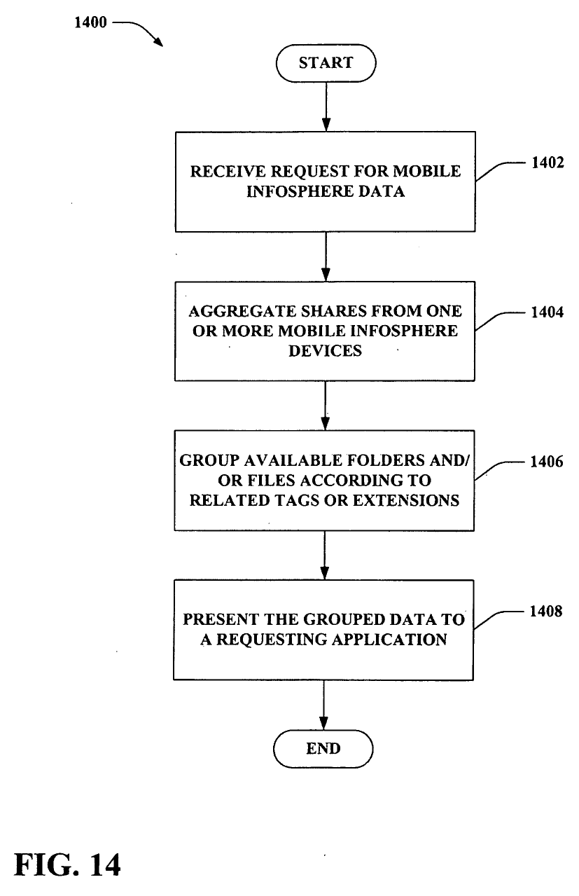

Turning now to FIG. 14, a methodology 1400 is illustrated that facilitates aggregating a plurality of mobile infosphere device share points for one or more applications to create a seamless view of the shares. At 1402, a request for infosphere data can be received. For example, this can be from a file system of one or more disparate devices; in one example, an application executing on the device can leverage the file system for the data. At 1404, shares from one or more mobile infosphere devices can be aggregated to provide seamless access to data on a plurality of mobile infosphere devices. At 1406, the available folders and/or files can be grouped according to related tags or extensions; thus, movies can be grouped together, music can be grouped, as can pictures, etc., regardless of the device on which they reside At 1408, the grouped data can be presented to a requesting application. For instance, in the file system example above, grouped listings of similarly typed files, e.g., movies, music, photos, and the like, can be presented to the file system, which can provide such to an application or interface allowing a user of the requesting device to select from a plurality of files regardless of source.

It will be appreciated that, in accordance with one or more aspects described herein, inferences can be made regarding grouping files or folders, obtaining access parameters, establishing secure connections, and/or the like as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

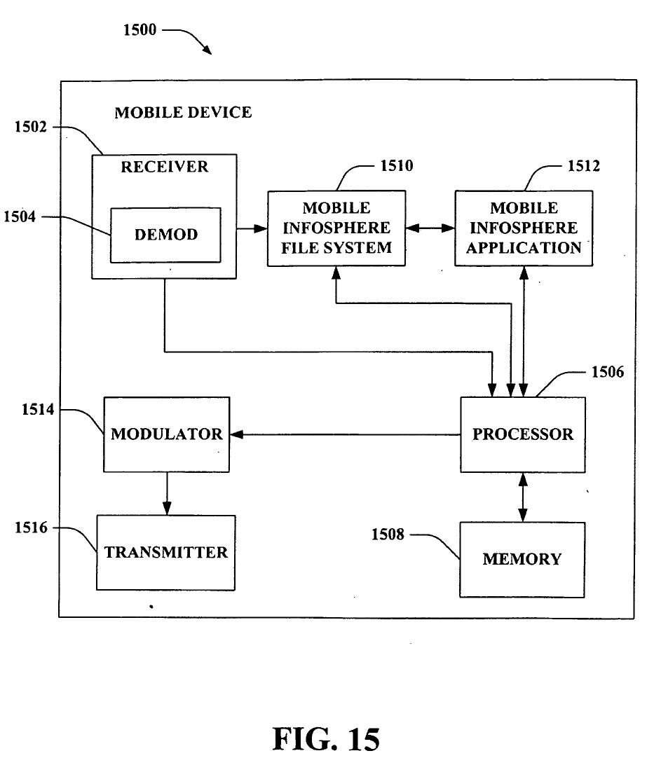

FIG. 15 is an illustration of a mobile device 1500 that facilitates communicating with one or more devices in its own or another mobile infosphere. Mobile device 1500 comprises a receiver 1502 that receives a signal from, for instance, a receive antenna (not shown), performs typical actions on (e.g., filters, amplifies, downconverts, etc.) the received signal, and digitizes the conditioned signal to obtain samples. Receiver 1502 can comprise a demodulator 1504 that can demodulate received symbols and provide them to a processor 1506 for channel estimation. Processor 1506 can be a processor dedicated to analyzing information received by receiver 1502 and/or generating information for transmission by a transmitter 1516, a processor that controls one or more components of mobile device 1500, and/or a processor that both analyzes information received by receiver 1502, generates information for transmission by transmitter 1516, and controls one or more components of mobile device 1500.

Mobile device 1500 can additionally comprise memory 1508 that is operatively coupled to processor 1506 and that can store data to be transmitted, received data, information related to available channels, data associated with analyzed signal and/or interference strength, information related to an assigned channel, power, rate, or the like, and any other suitable information for estimating a channel and communicating via the channel. Memory 1508 can additionally store protocols and/or algorithms associated with estimating and/or utilizing a channel (e.g., performance based, capacity based, etc.).

It will be appreciated that the data store (e.g., memory 1508 ) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1508 of the subject systems and methods is intended to comprise, without being limited to, these and any other suitable types of memory.

Processor 1506 and/or receiver 1502 can further be operatively coupled to a mobile infosphere file system 1510 that can establish communications with one or more mobile infosphere devices (e.g., via a registry server and/or the like as described) to receive data related thereto. For example, as described, the mobile infosphere file system 1510 can determine a plurality of accessible mobile infosphere devices having shared files and/or folders. In this way, the mobile infosphere file system 1510 can allow access to the files and folders available on the mobile infosphere devices. Moreover, a mobile infosphere application 1512 can be executing via the processor 1506 and can leverage the mobile infosphere file system 1510 to access one or more of the available files or folders as shown above. The files can relate to media content, productivity data, etc. In one example, the mobile infosphere application 1512 can be substantially any application that can utilize the file system aspects described herein to facilitate access to media or other files on the mobile infosphere file system 1510. This can be a BREW application and/or the like in one example. Mobile device 1500 still further comprises a modulator 1514 and transmitter 1516 that respectively modulate and transmit signal to, for instance, a base station, another mobile device, etc. Although depicted as being separate from the processor 1506, it is to be appreciated that the mobile infosphere file system 1510, BREW application 1512, demodulator 1504, and/or modulator 1514 can be part of the processor 1506 or multiple processors (not shown).

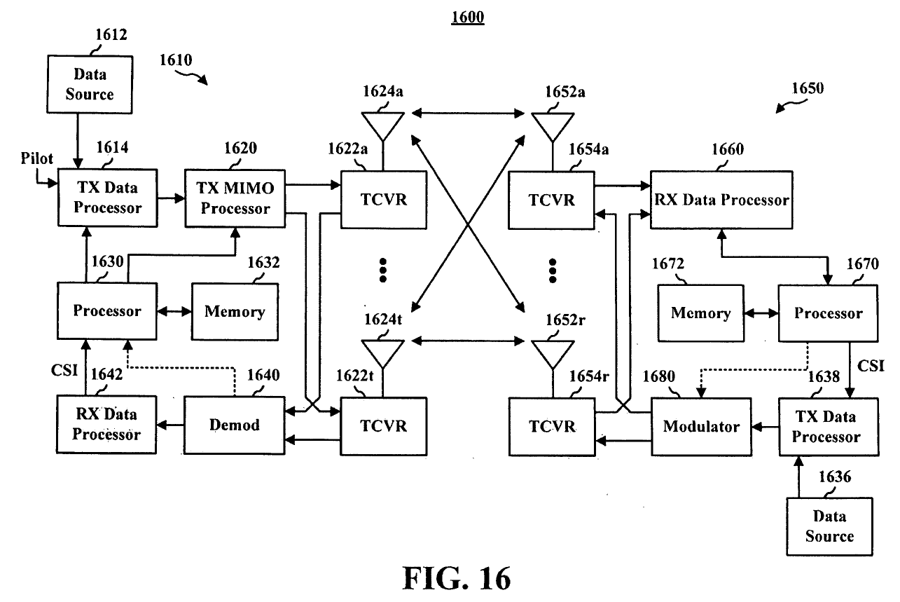

FIG. 16 shows an example wireless communication system 1600. The wireless communication system 1600 depicts one base station 1610 and one mobile device 1650 for sake of brevity. However, it is to be appreciated that system 1600 can include more than one base station and/or more than one mobile device, wherein additional base stations and/or mobile devices can be substantially similar or different from example base station 1610 and mobile device 1650 described below. In addition, it is to be appreciated that base station 1610 and/or mobile device 1650 can employ the systems (FIGS. 1-6 and 15), examples (FIG. 7-9) and/or methods (FIGS. 10-14) described herein to facilitate wireless communication there between.

At base station 1610, traffic data for a number of data streams is provided from a data source 1612 to a transmit (TX) data processor 1614. According to an example, each data stream can be transmitted over a respective antenna. TX data processor 1614 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1650 to estimate channel response. The multiplexed pilot and coded data for each data stream can be modulated (e.g. symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1630.

The modulation symbols for the data streams can be provided to a TX MIMO processor 1620, which can further process the modulation symbols (e.g., for OFDM). TX MIMO processor 1620 then provides N_{T} modulation symbol streams to N_{T} transceivers (TCVR) 1622a through 1622t. In various embodiments, TX MIMO processor 1620 applies beamforming weights to the symbols of the data streams and to the antenna from which the symbol is being transmitted.

Each transceiver 1622 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transceivers 1622a through 1622t are transmitted from N_{T} antennas 1624a through 1624t, respectively.

At mobile device 1650, the transmitted modulated signals are received by N_{R} antennas 1652a through 1652r and the received signal from each antenna 1652 is provided to a respective transceiver (TCVR) 1654a through 1654r. Each transceiver 1654 conditions (e.g., filters, amplifies, and downconverts) a respective signal, digitizes the conditioned signal to provide samples, and further processes the samples to provide a corresponding “received” symbol stream.

An RX data processor 1660 can receive and process the N_{R} received symbol streams from N_{R} transceivers 1654 based on a particular receiver processing technique to provide N_{T} “detected” symbol streams. RX data processor 1660 can demodulate, deinterleave, and decode each detected symbol stream to recover the traffic data for the data stream. The processing by RX data processor 1660 is complementary to that performed by TX MIMO processor 1620 and TX data processor 1614 at base station 1610.

A processor 1670 can periodically determine which precoding matrix to utilize as discussed above. Further, processor 1670 can formulate a reverse link message comprising a matrix index portion and a rank value portion.

The reverse link message can comprise various types of information regarding the communication link and/or the received data stream. The reverse link message can be processed by a TX data processor 1638, which also receives traffic data for a number of data streams from a data source 1636, modulated by a modulator 1680, conditioned by transceivers 1654 a through 1654 r, and transmitted back to base station 1610.

At base station 1610, the modulated signals from mobile device 1650 are received by antennas 1624, conditioned by transceivers 1622, demodulated by a demodulator 1640, and processed by a RX data processor 1642 to extract the reverse link message transmitted by mobile device 1650. Further, processor 1630 can process the extracted message to determine which precoding matrix to use for determining the beamforming weights.

Processors 1630 and 1670 can direct (e.g., control, coordinate, manage, etc.) operation at base station 1610 and mobile device 1650, respectively. Respective processors 1630 and 1670 can be associated with memory 1632 and 1672 that store program codes and data. Processors 1630 and 1670 can also perform computations to derive frequency and impulse response estimates for the uplink and downlink, respectively.

According to an example, the mobile device 1650 can request mobile infosphere device access through the base station 1610 as described herein. In particular, the base station 1610 can facilitate communication between the mobile device 1650 and a registry server (not shown). The mobile device 1650 can receive access parameters for one or more mobile infosphere devices, and establish communications with the device. For example, the base station 1610 can provide communicative access to the mobile infosphere device whether by direct connection, connection via one or more gateways in a mobile network (not shown) and/or the like as described herein. In addition, the base station 1610 can similarly contact the mobile device 1650 on behalf of other mobile infosphere devices to obtain information therefrom.

It is to be understood that the embodiments described herein can be implemented in hardware, software, firmware, middleware, microcode, or any combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

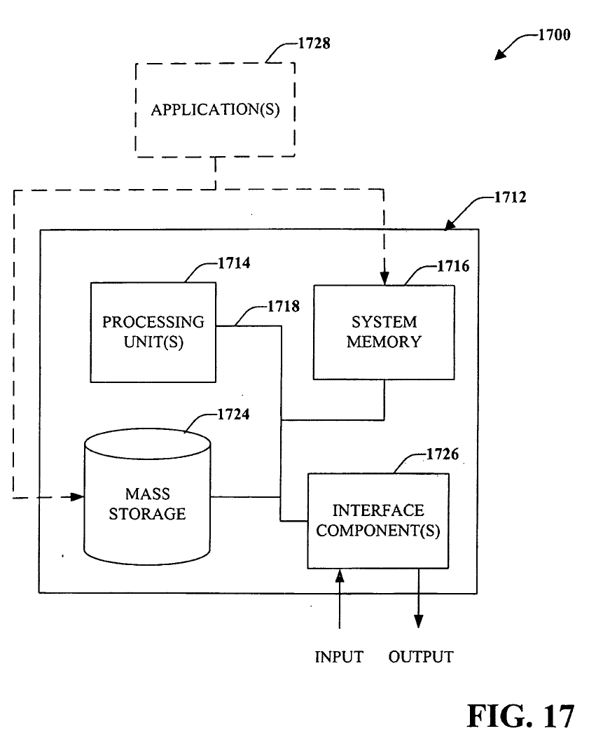

With reference to FIG. 17, an exemplary environment 1700 for implementing various aspects disclosed herein includes a computer 1712 (e.g., desktop, laptop, server, hand held, programmable consumer or industrial electronics . . . ). The computer 1712 includes a processing unit 1714, a system memory 1716 and a system bus 1718. The system bus 1718 couples system components including, but not limited to, the system memory 1716 to the processing unit 1714. The processing unit 1714 can be any of various available microprocessors. It is to be appreciated that dual microprocessors, multi-core and other multiprocessor architectures can be employed as the processing unit 1714.

The system memory 1716 includes volatile and nonvolatile memory. The basic input/output system (BIOS), containing the basic routines to transfer information between elements within the computer 1712, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1712 also includes removable/non-removable, volatile/non-volatile computer storage media. FIG. 17 illustrates, for example, mass storage 1724. Mass storage 1724 includes, but is not limited to, devices like a magnetic or optical disk drive, floppy disk drive, flash memory or memory stick. In addition, mass storage 1724 can include storage media separately or in combination with other storage media.

FIG. 17 provides software application(s) 1728 that act as an intermediary between users and/or other computers and the basic computer resources described in suitable operating environment 1700. Such software application(s) 1728 include one or both of system and application software. System software can include an operating system, which can be stored on mass storage 1724, that acts to control and allocate resources of the computer system 1712. Application software takes advantage of the management of resources by system software through program modules and data stored on either or both of system memory 1716 and mass storage 1724.

The computer 1712 also includes one or more interface components 1726 that are communicatively coupled to the bus 1718 and facilitate interaction with the computer 1712. By way of example, the interface component 1726 can be a port (e.g., serial, parallel, PCMCIA, USB, FireWire . . . ) or an interface card (e.g., sound, video, network . . . ) or the like. The interface component 1726 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1712 to output device(s) via interface component 1726. Output devices can include displays (e.g., CRT, LCD, plasma . . . ), speakers, printers and other computers, among other things.

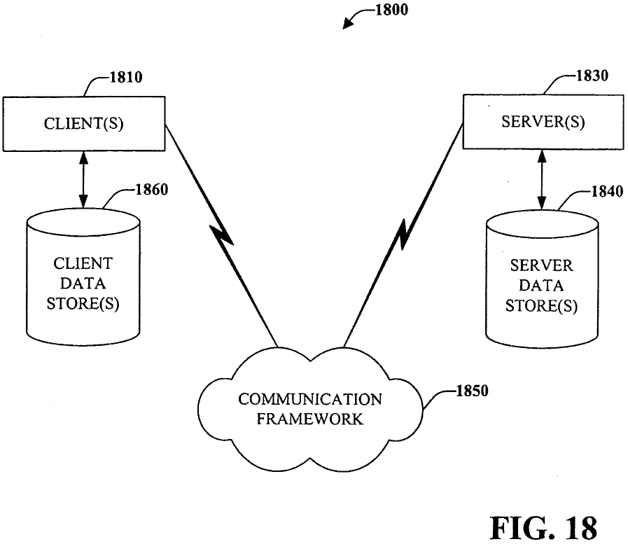

FIG. 18 is a schematic block diagram of a sample-computing environment 1800 with which the subject matter described herein can interact. The system 1800 includes one or more client(s) 1810. The client(s) 1810 can be hardware and/or software (e.g., threads, processes, computing devices). The system 1800 also includes one or more server(s) 1830. Thus, system 1800 can correspond to a two-tier client server model or a multi-tier model (e.g., client, middle tier server, data server), amongst other models. The server(s) 1830 can also be hardware and/or software (e.g., threads, processes, computing devices). The servers 1830 can house threads to perform transformations by employing the aspects of the subject innovation, for example. One possible communication between a client 1810 and a server 1830 may be in the form of a data packet transmitted between two or more computer processes.

The system 1800 includes a communication framework 1850 that can be employed to facilitate communications between the client(s) 1810 and the server(s) 1830. Here, the client(s) 1810 can correspond to program application components and the server(s) 1830 can provide the functionality of the interface and optionally the storage system, as previously described. The client(s) 1810 are operatively connected to one or more client data store(s) 1860 that can be employed to store information local to the client(s) 1810. Similarly, the server(s) 1830 are operatively connected to one or more server data store(s) 1840 that can be employed to store information local to the servers 1830.

By way of example, one or more clients 1810 can desire access one or more mobile infospheres or devices within the infosphere. Accordingly, as described, the one or more clients 1810 can communicate with a registry server, which can be server 1830 in this example, over the communication framework 1850. The registry server 1830 can provide access parameters to the clients 1810 for accessing the mobile infosphere or respective devices. Using the parameters, the clients 1810 can attain the access to facilitate media and/or other data transfer as described herein.

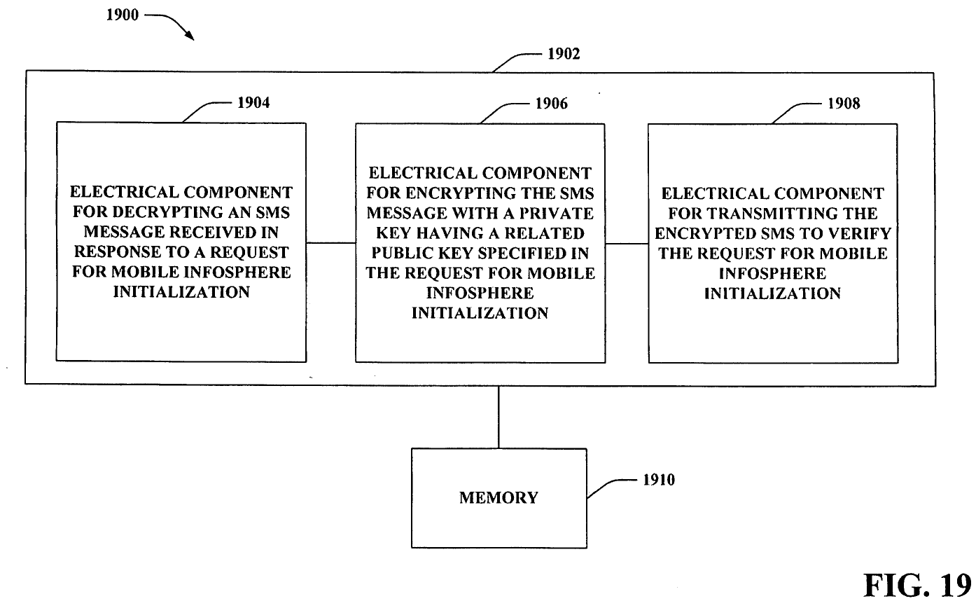

With reference to FIG. 19, illustrated is a system 1900 that facilitates creating a mobile infosphere related to a mobile device. For example, system 1900 can reside at least partially within a mobile device, base station, core network component, a centralized location, etc. It is to be appreciated that system 1900 is represented as including functional blocks, which can be functional blocks that represent functions implemented by a processor, software, or combination thereof (e.g., firmware). System 1900 includes a logical grouping 1902 of electrical components that can act in conjunction. For instance, logical grouping 1902 can include an electrical component for decrypting an SMS message received in response to a request for mobile infosphere initialization 1904. For example, as described, a mobile device, such as system 1900, can request initialization of a mobile infosphere based on its mobile phone number to facilitate access to devices related to the system 1900. The system 1900 can transmit access parameters in this message including one or more public security keys related to a private key held by the system 1900.

A registry server or other device can transmit an SMS to the system 1900 to verify registration encrypting the message with the public key; thus, the electrical component 1906 can decrypt with the private key to ensure validity of the communication. Thus, logical grouping 1902 can comprise an electrical component for encrypting the SMS message with a private key having a related public key specified in the request for mobile infosphere initialization 1906. Further, logical grouping 1902 can include an electrical component for transmitting the encrypted SMS to verify the request for mobile infosphere initialization 1908. For example, the SMS received can be re-encrypted with the system 1900 private key and/or a similar key pair related to the registry server or other device. In this regard, when the message is received from the system 1900, it can be verified to ensure identity of the system 1900. Additionally, system 1900 can include a memory 1910 that retains instructions for executing functions associated with electrical components 1904, 1906, and 1908. While shown as being external to memory 1910, it is to be understood that one or more of electrical components 1904, 1906, and 1908 can exist within memory 1910.

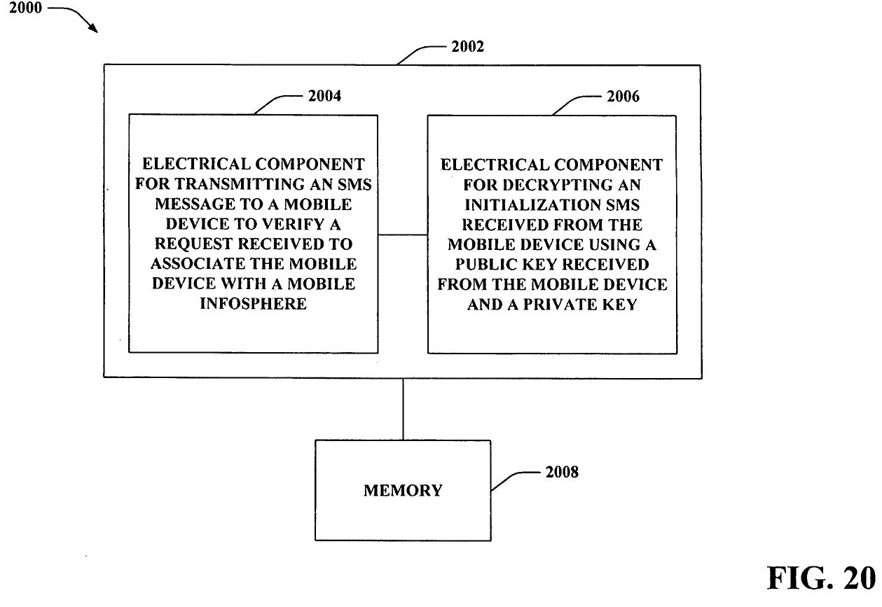

Turning to FIG. 20, illustrated is a system 2000 that facilitates creating a mobile infosphere related to a mobile device. System 2000 can reside within a base station, mobile device, etc., for instance. As depicted, system 2000 includes functional blocks that can represent functions implemented by a processor, software, or combination thereof (e.g., firmware). System 2000 includes a logical grouping 2002 of electrical components that facilitate initializing a mobile infosphere related to a mobile device. Logical grouping 2002 can include an electrical component for transmitting an SMS message to a mobile device to verify a request received to associate the mobile device with a mobile infosphere 2004. As described, a message to create a mobile infosphere can be received from a mobile device comprising access parameters for the device. Thus, to ensure validity of the request, an SMS can be transmitted using the access parameters, such as one or more keys to encrypt the SMS. Moreover, logical grouping 2002 can include an electrical component for decrypting an initialization SMS received from the mobile device using a public key received from the mobile device and a private key 2006. In this regard, the data can have been encrypted by the mobile device using a private key related thereto as well as a public key related to system 2000. Thus, the message is decrypted to ensure identity of the mobile device, at which point the mobile infosphere can be initialized. Additionally, system 2000 can include a memory 2008 that retains instructions for executing functions associated with electrical components 2004 and 2006. While shown as being external to memory 2008, it is to be understood that electrical components 2004 and 2006 can exist within memory 2008.

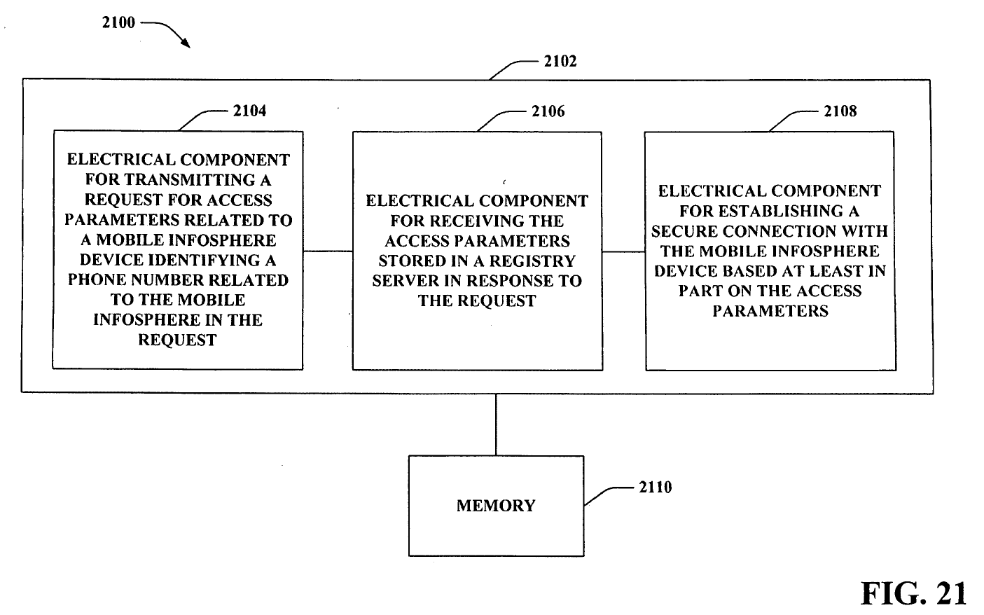

With reference to FIG. 21, illustrated is a system 2100 that facilitates accessing one or more mobile infosphere devices by requesting and utilizing related access parameters. For example, system 2100 can reside at least partially within a mobile device, base station, core network component, a centralized location, etc. It is to be appreciated that system 2100 is represented as including functional blocks, which can be functional blocks that represent functions implemented by a processor, software, or combination thereof (e.g., firmware). System 2100 includes a logical grouping 2102 of electrical components that can act in conjunction. For instance, logical grouping 2102 can include an electrical component for transmitting a request for access parameters related to a mobile infosphere device identifying a phone number related to the mobile infosphere device in the request 2104. Thus, as described, mobile infosphere devices can be associated via a mobile phone number of a device related to the infosphere devices. The phone number can be utilized to identify the requested device as well as an extension or other way to differentiate one device in the infosphere from another. Moreover, logical grouping 2102 can comprise an electrical component for receiving the access parameters stored in a registry server in response to the request 2106. In this regard, the access parameters can have been specified by the infosphere device upon association with the mobile infosphere; the parameters can include an address and/or one or more security keys that can be utilized to encrypt/decrypt communications to the infosphere device. Further, logical grouping 2102 can include an electrical component for establishing a secure connection with the mobile infosphere device based at least in part on the access parameters 2108. For example, the address can be utilized to communication with the device and communications can be encrypted with the security keys as described herein. Additionally, system 2100 can include a memory 2110 that retains instructions for executing functions associated with electrical components 2104, 2106, and 2108. While shown as being external to memory 2110, it is to be understood that one or more of electrical components 2104, 2106, and 2108 can exist within memory 2110.

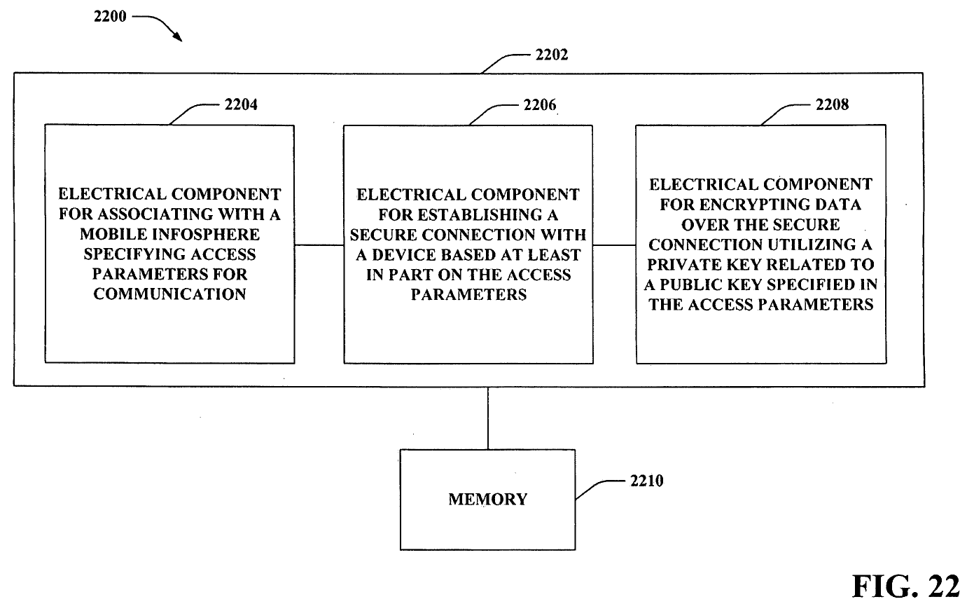

With reference to FIG. 22, illustrated is a system 2200 that facilitates receiving communication from one or more device based at least in part on access parameters specified during a mobile infosphere association request. For example, system 2200 can reside at least partially within a mobile device, base station, core network component, a centralized location, etc. It is to be appreciated that system 2200 is represented as including functional blocks, which can be functional blocks that represent functions implemented by a processor, software, or combination thereof (e.g., firmware). System 2200 includes a logical grouping 2202 of electrical components that can act in conjunction. For instance, logical grouping 2202 can include an electrical component for associating with a mobile infosphere specifying access parameters for communication 2204. Thus, as described, mobile infosphere devices can be requesting such association specifying an address and/or security keys, for example, in the request. These can facilitate communication with the device requesting association. Moreover, logical grouping 2202 can comprise an electrical component for establishing a secure connection with a device based at least in part on the access parameters 2206. In this regard, devices can request access to the system 2200 utilizing the access parameters as described herein. Further, logical grouping 2202 can include an electrical component for encrypting data over the secure connection utilizing a private key related to a public key specified in the access parameters 2208. For example, as described, the system 2200 can create a key pair where a private key is stored locally and a public key is given publically. In this regard, the system 2200 can encrypt data using its private key, and the public key can be utilized to decrypt the data verifying the identity of the system 2200. Additionally, system 2200 can include a memory 2210 that retains instructions for executing functions associated with electrical components 2204, 2206, and 2208. While shown as being external to memory 2210, it is to be understood that one or more of electrical components 2204, 2206, and 2208 can exist within memory 2210.

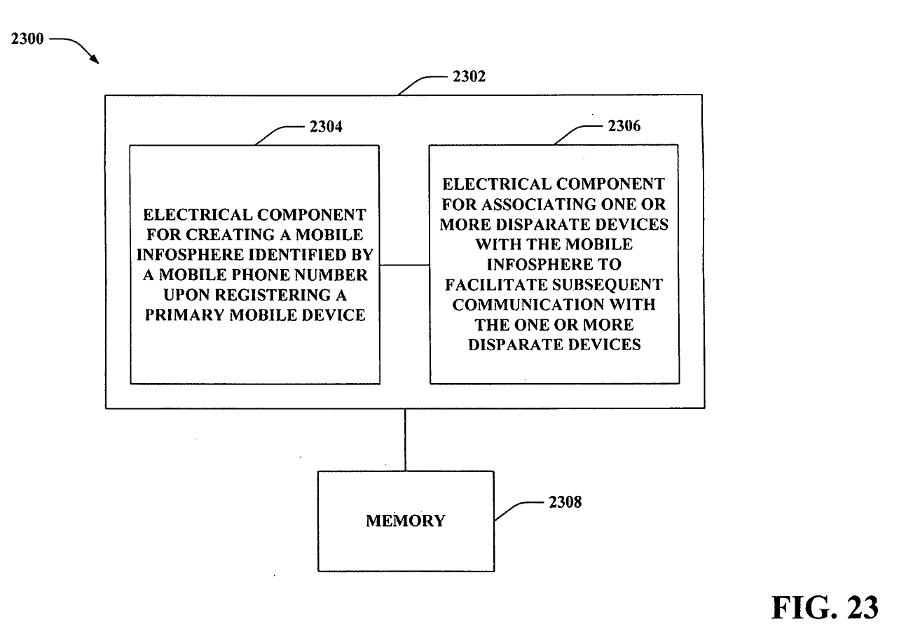

With reference to FIG. 23, illustrated is a system 2300 that facilitates maintaining a registry of mobile infosphere devices and access parameters for the devices. For example, system 2300 can reside at least partially within a base station, core network component, a centralized location, etc. It is to be appreciated that system 2300 is represented as including functional blocks, which can be functional blocks that represent functions implemented by a processor, software, or combination thereof (e.g., firmware). System 2300 includes a logical grouping 2302 of electrical components that can act in conjunction. For instance, logical grouping 2302 can include an electrical component for creating a mobile infosphere identified by a mobile phone number upon registering a primary mobile device 2304. For example, as described, a mobile device can register with a registry server to create a mobile infosphere related to the device. In this regard, the infosphere can be identified by the phone number of the device, as this is typically unique and related to a person. Further, logical grouping 2302 can comprise an electrical component for associating one or more disparate devices with the mobile infosphere to facilitate subsequent communication with the one or more devices 2306. Thus, in one example, access requests for the disparate devices can be received identifying the devices by the mobile phone number and some extension. Thus, an application can access available devices of a user related to the mobile phone number, in one example. Additionally, system 2300 can include a memory 2308 that retains instructions for executing functions associated with electrical components 2304 and 2306. While shown as being external to memory 2308, it is to be understood that one or more of electrical components 2304 and 2306 can exist within memory 2308.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates securely accessing devices of a mobile infosphere, comprising:
receiving a short message service (SMS) message including an encrypted payload in response to a registration request to a registry server;
decrypting the payload using a first public key from the registry server and a private key related to a second public key transmitted in the registration request;
encrypting the payload with the private key and the first public key; and
transmitting the encrypted payload to complete registry server registration creating a mobile infosphere.

2. A wireless communications apparatus, comprising:
at least one processor configured to:
obtain a short message service (SMS) message in response to requesting mobile infosphere initialization in a registry server;
decrypt the SMS message using a public key of the registry server and a private key transmitted in requesting mobile infosphere initialization;
encrypt the decrypted SMS message using the public key and private key pair for verification; and
transmit the encrypted SMS message to the registry server to initialize the mobile infosphere; and
a memory coupled to the at least one processor.

3. The wireless communications apparatus of claim 2, the at least one processor further configured to generate the private key along with a related public key and transmit the public key in requesting mobile infosphere initialization.

4. The wireless communications apparatus of claim 2, the at least one processor further configured to receive an association SMS message to verify a device for association with the mobile infosphere.

5. The wireless communications apparatus of claim 4, the association SMS message comprises an identification.

6. The wireless communications apparatus of claim 5, a binary runtime for wireless (BREW) application verifies the identification against an identification specified in requesting mobile infosphere initialization.

7. The wireless communications apparatus of claim 2, the at least one processor further configured to transmit a request comprising a mobile phone number to a registry server in requesting mobile infosphere initialization.

8. The wireless communications apparatus of claim 7, the mobile infosphere is associated with the mobile phone number for subsequent identification of associated devices.

9. The wireless communications apparatus of claim 2, the at least one processor further configured to update the private key and transmit the updated private key to registry server.

10. A wireless communications apparatus that initializes a mobile infosphere with a registry server, comprising:
means for decrypting a short message service (SMS) message received in response to a request for mobile infosphere initialization;
means for encrypting the SMS message with a private key having a related public key specified in the request for mobile infosphere initialization; and
means for transmitting the encrypted SMS to verify the request for mobile infosphere initialization.

11. The wireless communications apparatus of claim 10, further comprising means for receiving an association SMS message in response to a request by a disparate device for mobile infosphere association.

12. The wireless communications apparatus of claim 10, further comprising means for refreshing the private and public keys and transmitting the refreshed public key for association with the initialized mobile infosphere.

13. The wireless communications apparatus of claim 10, the request for mobile infosphere initialization comprising a mobile phone number for identifying the mobile infosphere in association and/or access requests.

14. A computer program product, comprising:
a computer-readable medium comprising:
code for causing at least one computer to receive a short message service (SMS) message including an encrypted payload in response to a registration request to a registry server;
code for causing the at least one computer to decrypt the payload using a first public key from the registry server and a private key related to a second public key transmitted in the registration request;
code for causing the at least one computer to encrypt the payload with the private key and the first public key; and
code for causing the at least one computer to transmit the encrypted payload to complete registry server registration creating a mobile infosphere.

15. A method for associating a plurality of devices in a mobile infosphere, comprising:
receiving a request to initialize a mobile infosphere from a mobile device comprising a public key for encrypting communication to the mobile device;
transmitting a short message service (SMS) message comprising a payload encrypted with a public key of a mobile device and a private key to the mobile device;
decrypting a response message with the public key of the mobile device and the private key; and
initializing the mobile infosphere for the mobile device based at least in part on comparing the response message with the SMS message.

16. A wireless communications apparatus, comprising:
at least one processor configured to:
encrypt a short message service (SMS) message using a public key of a mobile device and a private key;
transmit the SMS message to the mobile device to verify a request received for initializing a mobile infosphere related to the mobile device; and
initialize the mobile infosphere upon receiving a verification SMS from the mobile device; and
a memory coupled to the at least one processor.

17. The wireless communications apparatus of claim 16, the at least one processor is further configured to decrypt the verification SMS message using the public key of the mobile device and the private key to ensure identity of the mobile device.

18. The wireless communications apparatus of claim 16, the private key is received from the mobile device in the request received for initializing the mobile infosphere.

19. The wireless communications apparatus of claim 16, the at least one processor further configured to receive a request from a disparate device to join the mobile infosphere of the mobile device.

20. The wireless communications apparatus of claim 19, the at least one processor further configured to transmit an association SMS to the mobile device to verify association of the disparate device with the mobile infosphere.

21. The wireless communications apparatus of claim 20, the at least one processor further configured to receive a verification SMS related to association of the disparate device and decrypt the verification SMS utilizing the public key of the mobile device and the private key.

22. The wireless communications apparatus of claim 21, the at least one processor further configured to associate the disparate device with the mobile infosphere based at least in part on the verification SMS.

23. The wireless communications apparatus of claim 16, the at least one processor further configured to identify the mobile infosphere utilizing a phone number of the mobile device.

24. The wireless communications apparatus of claim 16, the at least one processor further configured to receive and process an update for the public key of the mobile device.

25. A wireless communications apparatus that facilitates initializing a mobile infosphere for subsequent device association, comprising:
means for transmitting a short message service (SMS) message to a mobile device to verify a request received to associate the mobile device with a mobile infosphere; and
means for decrypting an initialization SMS received from the mobile device using a public key received from the mobile device and a private key.

26. The wireless communications apparatus of claim 25, further comprising means for encrypting the SMS message using the public key of the mobile device and the private key.

27. A computer program product, comprising:
a computer-readable medium comprising:
code for causing at least one computer to receive a request to initialize a mobile infosphere from a mobile device comprising a public key for encrypting communication to the mobile device;
code for causing the at least one computer to transmit a short message service (SMS) message comprising a payload encrypted with a public key of a mobile device and a private key to the mobile device;
code for causing the at least one computer to decrypt a response message with the public key of the mobile device and the private key; and
code for causing at least one computer to initialize the mobile infosphere for the mobile device based at least in part on comparing the response message with the SMS message.

28. A method that facilitates communication among a plurality of mobile infosphere devices, comprising:
transmitting a request for access parameters for at least one of a plurality of mobile infosphere devices from a registry server that associates a plurality of devices with a mobile infosphere based at least in part on a mobile phone number for the mobile infosphere; and
utilizing the access parameters to establish secure communications with the at least one mobile infosphere device.

29. A wireless communications apparatus, comprising:
at least one processor configured to:
transmit a request for access parameters related to a mobile infosphere device, the request identifies the device using a mobile phone number associated with the mobile infosphere; and
establish a secure communication session with the mobile infosphere device using the access parameters; and
a memory coupled to the at least one processor.

30. The wireless communications apparatus of claim 29, the at least one processor further configured to associate an extension with the mobile phone number to request access parameters for a device associated with the mobile phone number identified by the extension.

31. The wireless communications apparatus of claim 29, the at least one processor further configured to execute a file system that creates the request for access parameters related to the mobile infosphere device, the files system requests access parameters for at least one disparate mobile infosphere devices.

32. The wireless communications apparatus of claim 31, the file system aggregates data from the mobile infosphere device and the disparate mobile infosphere device into a single view.

33. The wireless communications apparatus of claim 29, the at least one processor further configured to transcode data for transmission to the mobile infosphere device by at least one of reducing quality of the data and/or selecting a portion of the data based at least in part on a type of the mobile infosphere device.

34. The wireless communications apparatus of claim 33, the at least one processor further configured to transmit the transcoded data to the mobile infosphere device over the secure connection.

35. The wireless communications apparatus of claim 29, the at least one processor further configured to receive data from the mobile infosphere device over the secure connection.

36. The wireless communications apparatus of claim 35, the received data is transcoded based at least in part on a type of the wireless communications apparatus.

37. The wireless communications apparatus of claim 29, the at least one processor further configured to encrypt data transmitted over the secure connection utilizing a public key of the mobile infosphere device specified in the access parameters as well as a private key.

38. The wireless communications apparatus of claim 29, the secure connection is established via a proxy server specified in the access parameters.

39. A wireless communications apparatus that facilitates secure mobile infosphere device communication, comprising:
means for transmitting a request for access parameters related to a mobile infosphere device identifying a phone number related to the mobile infosphere in the request;
means for receiving the access parameters stored in a registry server in response to the request; and
means for establishing a secure connection with the mobile infosphere device based at least in part on the access parameters.

40. A computer program product, comprising:
a computer-readable medium comprising:
code for causing at least one computer to transmit a request for access parameters for at least one of a plurality of mobile infosphere devices from a registry server that associates a plurality of devices with a mobile infosphere based at least in part on a mobile phone number for the mobile infosphere; and
code for causing the at least one computer to utilize the access parameters to establish secure communications with the at least one mobile infosphere device.

41. A method for facilitating secure mobile infosphere device communication, comprising:
specifying access parameters, including an address and a public key corresponding to a locally stored private key, in a request to associate with a mobile infosphere created by a registry server;
establishing a secure connection with a device based at least in part on access parameters;
encrypting communications over the secure connection with the private key.

42. A wireless communications apparatus, comprising:
at least one processor configured to:
transmit access parameters for communicating with the wireless communications apparatus in a request to associate with a mobile infosphere created in a registry server;
establish a secure communication session with a device using the access parameters; and
secure data for communication in the session utilizing security keys related to the access parameters; and
a memory coupled to the at least one processor.

43. The wireless communications apparatus of claim 42, the access parameters specify at least one public security key related to a private security key stored locally in the wireless communications apparatus.

44. The wireless communications apparatus of claim 43, the at least one processor further configured to encrypt the data utilizing the private security key.

45. The wireless communications apparatus of claim 42, the at least one processor further configured to establish connection with a proxy server to facilitate access to the wireless communications apparatus.

46. The wireless communications apparatus of claim 45, an address of the proxy server is specified within the access parameters.

47. The wireless communications apparatus of claim 42, the at least one processor further configured to receive transcoded data over the secure communication session, the transcoded data is transcoded according to capabilities of the wireless communications apparatus.

48. The wireless communications apparatus of claim 42, the at least one processor further configured to transcode data according to a type of the device and transmit the transcoded data to the device.

49. A wireless communications apparatus that facilitates secure communication between mobile infosphere devices, comprising:
means for associating with a mobile infosphere specifying access parameters for communication;
means for establishing a secure connection with a device based at least in part on the access parameters; and
means for encrypting data over the secure connection utilizing a private key related to a public key specified in the access parameters.

50. A computer program product, comprising:
a computer-readable medium comprising:
code for causing at least one computer to specify access parameters, including an address and a public key corresponding to a locally stored private key, in a request to associate with a mobile infosphere created by a registry server;
code for causing the at least one computer to establish a secure connection with a device based at least in part on access parameters;
code for causing the at least one computer to encrypt communications over the secure connection with the private key.

51. A method that facilitates securely accessing devices of mobile infosphere, comprising:
associating a plurality of devices with a mobile infosphere identified by a mobile phone number; and
providing access parameters for the plurality devices to one or more disparate devices.

52. A wireless communications apparatus, comprising:
at least one processor configured to maintain a mobile infosphere index comprising a number of devices each associated with one of a plurality of mobile device phone numbers; and
a memory coupled to the at least one processor.

53. The wireless communications apparatus of claim 52, the at least one processor further configured to add a mobile device to the mobile infosphere index upon request at least in part by receiving a confirmation based on an encrypted short message service (SMS) message transmitted to the mobile device.

54. The wireless communications apparatus of claim 52, the at least one processor further configured to add a mobile infosphere device associated with a mobile device phone number to the mobile infosphere index at least in part by receiving confirmation from a mobile device assigned to the mobile device phone number.

55. The wireless communications apparatus of claim 53, confirmation is based at least in part on the mobile device receiving an identifier specified by the mobile infosphere device.

56. The wireless communications apparatus of claim 52, the at least one processor further configured to provide access parameters related to one or more mobile infosphere devices to a disparate device requesting access to the one or more mobile infosphere devices.

57. The wireless communications apparatus of claim 56, the disparate device is within the same mobile infosphere as the one or more mobile infosphere devices according to the mobile infosphere index.

58. The wireless communications apparatus of claim 56, the at least one processor further configured to facilitate secure connection of the disparate device with the one or more mobile infosphere devices by providing the access parameters.

59. A wireless communications apparatus that facilitates communication between devices of participating in mobile infospheres, comprising:
means for creating a mobile infosphere identified by a mobile phone number upon registering a primary mobile device; and
means for associating one or more disparate devices with the mobile infosphere to facilitate subsequent communication with the one or more disparate devices.

60. A computer program product, comprising:
a computer-readable medium comprising:
code for causing at least one computer to associate a plurality of devices with a mobile infosphere identified by a mobile phone number; and
code for causing the at least one computer to provide access parameters for the plurality devices to one or more disparate devices.
